(19) United States
(12) Patent Application Publication
(10) Pub. No.: US 2011/0238959 A1
(43) Pub. Date: Sep. 29, 2011

(54) DISTRIBUTED CONTROLLER, DISTRIBUTED PROCESSING SYSTEM, AND DISTRIBUTED PROCESSING METHOD

(75) Inventors: Arata SHINOZAKI, Tokyo (JP); Takayuki NAKATOMI, Tokyo (JP); Mitsunori KUBO, Tokyo (JP)

(73) Assignee: OLYMPUS CORPORATION, Tokyo (JP)

(21) Appl. No.: 13/069,757

(22) Filed: Mar. 23, 2011

(30) Foreign Application Priority Data
Mar. 24, 2010 (JP) 2010-068864

(51) Int. Cl. G06F 9/315

(52) U.S. Cl. 712/225; 712/E09.034

(57) ABSTRACT

A distributed controller is connected to two or more processing elements and controls the two or more processing elements to execute distributed processing. The distributed controller comprises a plurality of control modules, each of which is connected to at least one other control module. The distributed controller determines a processing path between processing elements using at least two of the plurality of control modules.

### CROSS-REFERENCE TO RELATED APPLICATION

The present application is based upon and claims the benefit of priority from the prior Japanese Patent Application No. 2010-068864 filed on Mar. 24, 2010; the entire contents of which are incorporated herein by reference.

### BACKGROUND OF THE INVENTION

1. Field of the Invention

The present invention relates to a distributed controller, a distributed processing system, and a distributed processing method.

2. Description of the Related Art

Examples of conventional distributed controllers, distributed processing systems, and distributed processing methods include a distributed controller disclosed in Japanese Patent Application Laid-Open No. 2004-352459, a multi-processor system disclosed in Japanese Patent Application Laid-Open No. 2009-129219, and a distributed processing system disclosed in Japanese Patent No. 3006187.

### SUMMARY OF THE INVENTION

A distributed controller according to the present invention is connected to processing elements and controls two or more processing elements to execute distributed processing. The distributed controller comprises a plurality of control modules, each of which is connected to at least one other control module. The distributed controller determines a processing path between processing elements using at least two of the plurality of control modules.

A distributed processing system according to the present invention comprises two or more processing elements and a distributed controller that is connected to the two or more processing elements and controls the two or more processing elements to execute distributed processing, wherein the distributed controller comprises a plurality of control modules, each of the control modules is connected to at least one other control module, and a processing path between the processing elements is determined using at least two of the plurality of control modules.

A distributed processing method according to the present invention is a distributed processing method for a distributed processing system including two or more processing elements and a distributed controller connected to the two or more processing elements, the distributed controller including a plurality of control modules, each of the control module being connected to at least one other control module. The distributed processing method comprises determining a processing path between the processing elements using at least two of the plurality of control modules, and executing distributed processing by the processing elements in the processing path under control of the distributed controller.

### BRIEF DESCRIPTION OF THE DRAWINGS

FIG. 1 is a diagram showing the basic configuration of a distributed processing system;

FIG. 2 is a flow chart of a JPEG decoding process;

FIG. 3 is a diagram showing a system that executes the JPEG decoding process in the distributed processing system shown in FIG. 1;

FIG. 4 is a task configuration table as an example of task configuration information for the JPEG decoding process;

FIG. 5 is a table showing an exemplary configuration of a static information table in the distributed processing system shown in FIG. 1;

FIG. 6 is a table showing an exemplary configuration of a dynamic information table in the distributed processing system shown in FIG. 1;

FIG. 7 is a diagram showing a processing path table in a case where the JPEG decoding process is executed with the system configuration shown in FIG. 3;

FIG. 8 is a diagram showing the internal configuration of a control unit according to a first embodiment;

FIG. 9 is a diagram showing the overall configuration of a distributed processing system as well as the internal configuration of the control unit according to the first embodiment;

FIG. 10 is a diagram showing a physical network in which control modules are assigned;

FIG. 11 is a chart showing the order of processing in a JPEG decoding process with the system configuration shown in FIG. 9;

FIG. 12 is a chart of a start-up sequence of the control modules according to the first embodiment;

FIG. 13 is a table showing an exemplary configuration of control module information;

FIG. 14 is a table showing an exemplary configuration of a control module management table;

FIG. 15 is a chart of a sequence of a reconnection of the control modules;

FIG. 16 is a diagram showing the basic overall configuration of a distributed processing system as well as the internal configuration of a control unit according to a second embodiment;

FIG. 17 is a chart of a connection sequence in a case where a processing path determination section serves as a master and a management section serves as a slave;

FIG. 18 is a table showing control module information held by the management section after the completion of the entire sequence shown in FIG. 17;

FIG. 19 is a diagram showing the basic overall configuration of a distributed processing system as well as the internal configuration of an extended control unit;

FIG. 20 is a control module management table in the management section after the connection of a processing path determination section;

FIG. 21 is a chart showing the order of processing in the JPEG decoding process with the system configuration shown in FIG. 19.

FIG. 22 is a diagram showing the configuration of a distributed processing system including a control unit having only one integrated management section;

FIG. 23 is a diagram showing the overall configuration of a distributed processing system as well as the internal configuration of a control unit according to a third embodiment;

FIG. 24 is a flowchart of a procedure to be followed when a control module becomes unavailable according to the third embodiment;

FIG. 25 is a diagram showing the overall configuration of a distributed processing system as well as the internal configuration of a control unit according to a fourth embodiment;

FIG. 26 is a flow chart of a copy process in a management section;

FIG. 27 is a flow chart of a copy process in a start-up section;

FIG. 28 is a diagram showing the overall configuration of the processing system as well as the internal configuration of the control unit after the completion of the copy process according to the fourth embodiment; and

FIG. 29 is a diagram showing the overall configuration of the distributed processing system after the completion of the copy process in the start-up section, in which the control unit has been started.

### DETAILED DESCRIPTION OF THE INVENTION

In the following, embodiments of the distributed controller, the distributed processing system, and the distributed processing method according to the present invention will be described in detail with reference to the accompanying drawings. It should be understood that the invention is not limited to the embodiments.

In the distributed controller, the distributed processing system, and the distribution processing method according to the embodiments, the control function is divided and assigned to a plurality of function modules, and the modules can be distributed in a network. Thus, each module can be independently updated or maintained, and the maintainability can be improved. Here, the maintainability refers to that in routine maintenance.

Since the modules can be distributed in a network, even if a module or the platform on which the modules run (e.g. a personal computer) becomes unavailable, an alternate module can be activated. Thus, the recovery is made easy, and failure tolerance is improved. Here, the term “failure tolerance” refers to the maintainability at the time of failure.

Furthermore, a management section may be provided, and a plurality of function modules that provide the same function in different ways may be registered. Then, scalability of the system can be enhanced. Here, the term “scalability of system” refers to the maintainability at the time of updating the system.

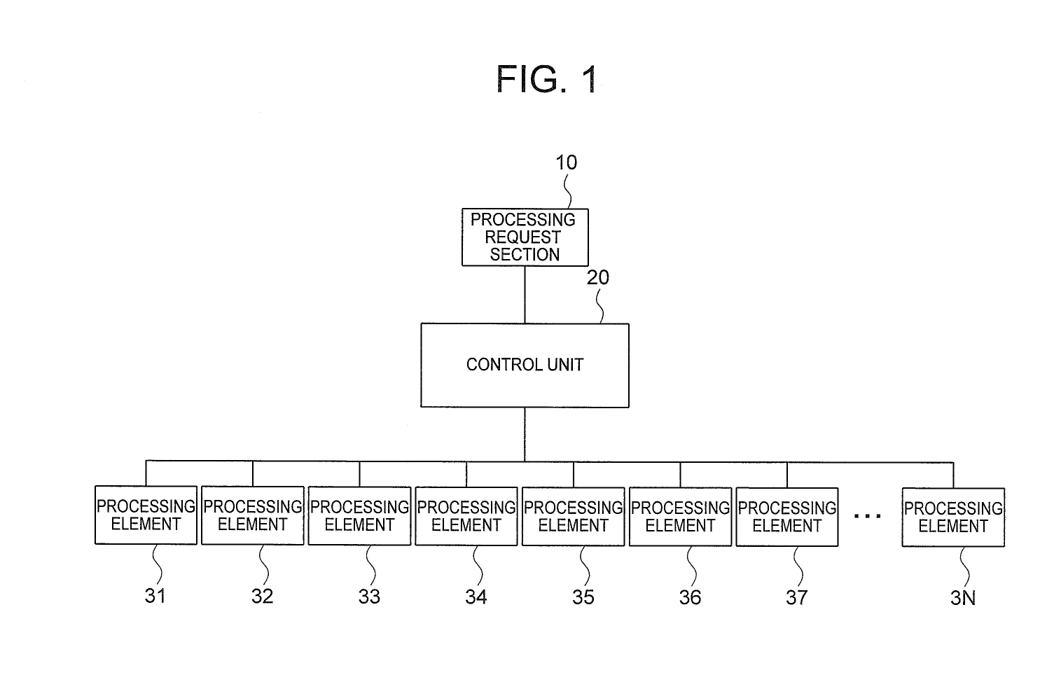

FIG. 1 shows the basic configuration of a distributed processing system.

As shown in FIG. 1, the distributed processing system includes a processing request section 10, a control unit 20 serving as a distributed controller, and an N number of processing elements 31, 32, 33, 34, 35, 36, 37, . . . , 3N, where N is a natural number. Each processing element has a specific data processing function. The control unit 20 accepts a data processing requested by a processing request section 10, determines whether or not the requested data processing can be provided by a combination of the specific data processing functions that the respective processing elements provide, and selects optimal processing elements. Then, the control unit 20 defines communication paths between the selected processing elements. The control unit 20 notifies the selected processing elements of the communication paths thus defined so that the processing elements dynamically create the communication paths, thereby dynamically configuring a processing system.

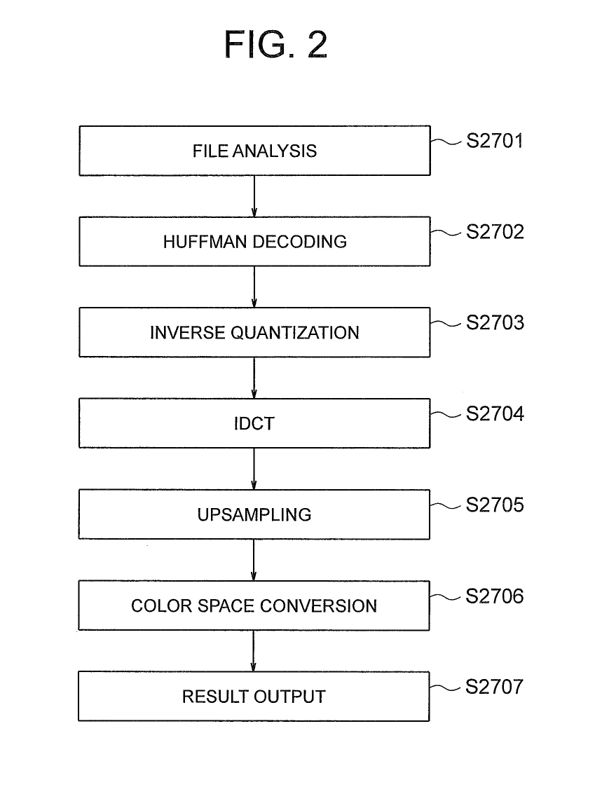

As an example of the distributed processing system, a case in which a JPEG (Joint Photographic Experts Group) decoding process is requested by the processing request section 10 as a data processing will be described. FIG. 2 is a flow chart of the JPEG decoding process.

The JPEG decoding process is defined as a sequential process consisted of seven processing stages including JPEG file analysis S2701, Huffman decoding S2702, inverse quantization S2703, IDCT (Inverse Discrete Cosine Transform) S2704, upsampling S2705, color space conversion S2706, and result output S2707. Here, the processing elements 31, 32, 33, 34, 35, 36, and 37 shall provide the processes in the respective processing stages S2701 to S2707 as services.

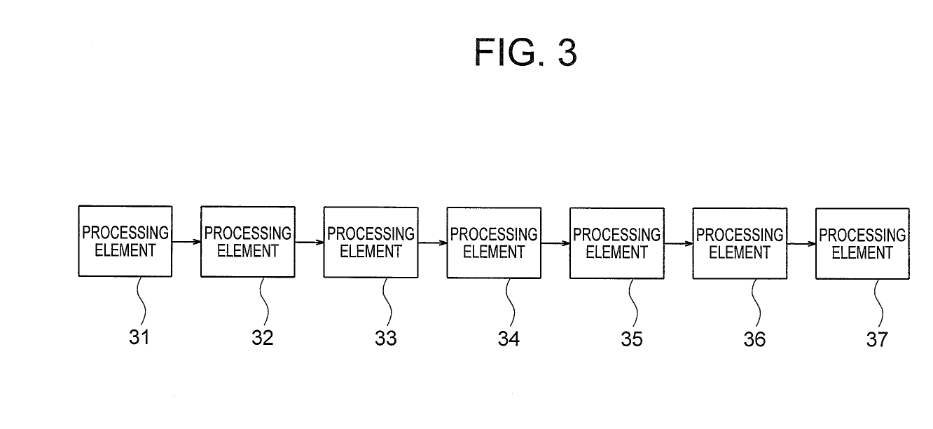

The control unit 20 selects the processing elements 31, 32, 33, 34, 35, 36, and 37 as processing elements capable of executing the JPEG decoding process and dynamically establishes the paths between the processing elements. In other word, the control unit 20 dynamically constructs a JPEG decoding processing system shown in FIG. 3. FIG. 3 shows a system that executes the JPEG decoding process in the distributed processing system shown in FIG. 1.

The control unit 20 has task configuration information and processing element information in order to dynamically construct the processing system and dynamically creates processing path information that defines the system, based on the task configuration information and the processing element information.

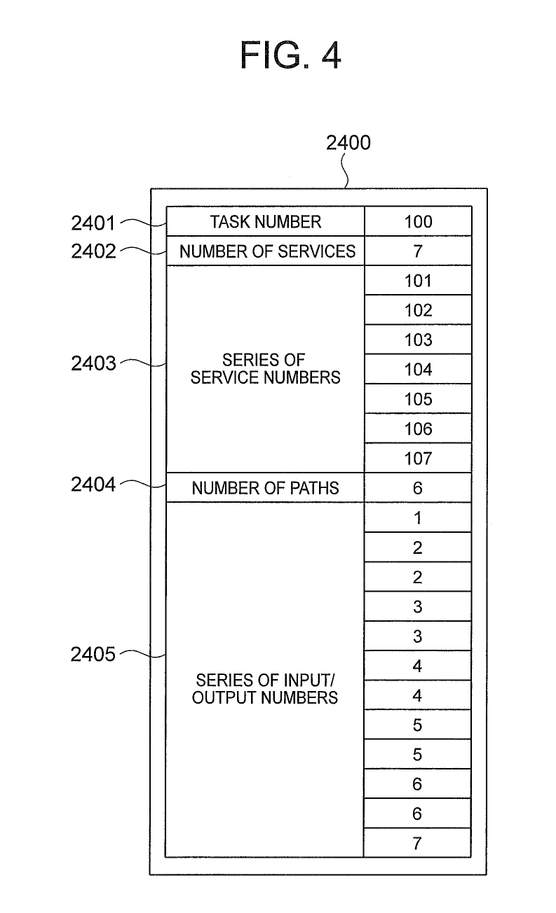

FIG. 4 shows a task configuration table as an example of the task configuration information for the JPEG decoding process.

The task configuration table 2400 shown in FIG. 4 is a data structure in which a task, the services that constitute the task, and the paths between the services are defined. The task configuration table 2400 contains the task number 2401 specific to the task, the number of services 2402, which constitute the task, a series of service numbers 2403 specific to (or uniquely assigned to) the services that constitute the task, the number of the paths between the services 2404, and a series of input/output numbers 2405, which define the input and output of the paths.

Examples of specific numerals of the aforementioned items are shown in FIG. 4. Specifically, in the illustrated case, the task number of the JPEG decoding process is 100, and the service numbers of the file analysis, Huffman decoding, inverse quantization, IDCT, upsampling, color space conversion, and result output are 101, 102, 103, 104, 105, 106, and 107 respectively. The series of input/output numbers 2405 are represented by internal representations, which are referred to as “indices”. The indices represent the order of the services specified in the series of service numbers 2403. For example, the index “1” corresponds to the first service 101 in the series of service numbers, and the index “7” corresponds to the seventh service 107 in the series of service numbers.

The series of input/output numbers 2405 are represented by input-and-output pairs arranged in order from above. For example, the first path has the service represented by index 1 as the input and the service represented by index 2 as the output. Similarly, the sixth path has the service represented by index 6 as the input and the service represented by index 7 as the output.

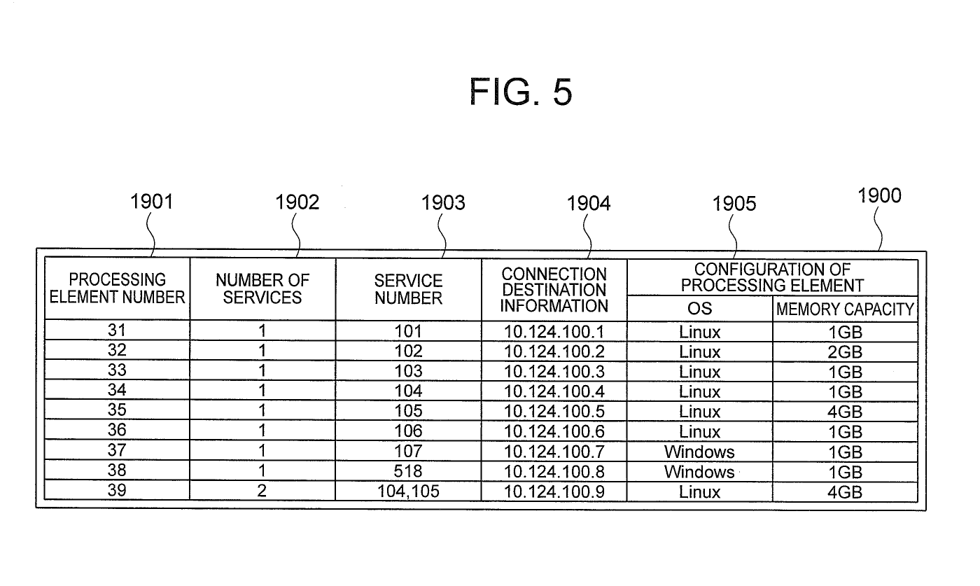

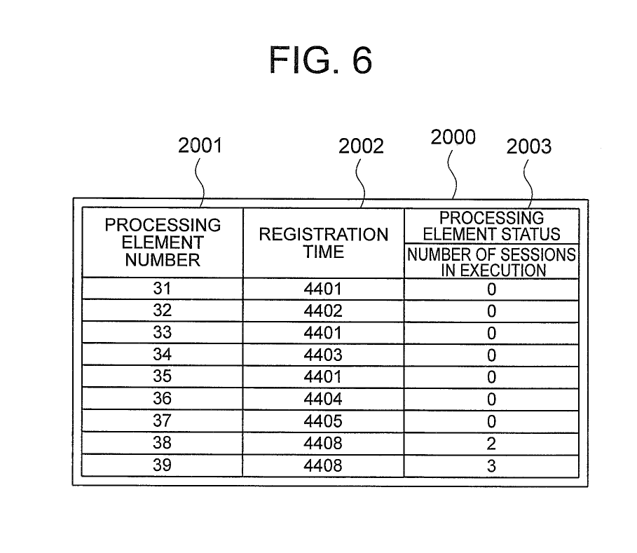

Now, the processing element information will be described with reference to FIGS. 5 and 6.

The processing element information contains static information and dynamic information. FIG. 5 is a table showing an exemplary configuration of a static information table 1900 in the distributed processing system shown in FIG. 1. Although only information for the processing elements up to the processing element 39 is shown in FIG. 5 for the sake of simplicity, the static information table 1900 contains information for all the processing elements that are connected to the control unit 20. The control unit 20 manages the processing elements connected thereto using the static information table 1900. The static information table 1900 contains the processing element numbers 1901 or numbers specific to (or uniquely assigned to) the respective processing elements, the number 1902 of services that can be provided by the processing elements, the service numbers 1903 of the services that the respective processing elements can provide, connection destination information 1904 of the processing elements, and processing element configuration 1905.

The processing element configuration 1905 is static information about the configurations of the processing elements. The processing element configuration 1905 includes information on the OS (operating system), the memory capacity, the storage capacity, the processor architecture, and the network communication speed. One processing element can provide two or more services. The service is selected based on conditions in data processing. The conditions in data processing include the data type, such as an image or a character string, identified by the data header, the processing order of the data, and the status of the processing element including, for example, the processing load. The selection of the services may be made by sending parameters that designate the services from the control unit. Although information on the OS and the memory capacity is shown as the processing element configuration 1905 in FIG. 5, the processing element configuration 1905 is not limited to this.

In FIG. 5, the IP address is shown as the connection destination information 1904. However, the connection destination information 1904 may include the port number or the channel number corresponding to the input/output of hardware. The connection destination information 1904 may be fixed information determined between communicating parties to provide only fixed connection destinations, or alternatively other connection destinations may be determined before communication using the fixed connection destinations.

Each processing element makes a connection to the control unit 20 upon activation to notify the control unit 20 of its activation. Each processing element also notifies the control unit 20 of the processing element number, the number of services, the service number(s), and the processing element configuration. The control unit 20 updates the static information table 1900 based on the information provided by the above notifications.

In the following, a description will be made of the dynamic processing element information (dynamic information) with reference to FIG. 6. FIG. 6 is a table showing an example of a dynamic information table 2000 in the distributed processing system shown in FIG. 1. Although only information for the processing elements up to the processing element 39 is shown in FIG. 6 for the sake of simplicity, the dynamic information table 2000 contains information for all the processing elements that are connected to the control unit 20. The dynamic information table 2000 contains the processing element number 2001, the registration time 2002, and the processing element status 2003.

In the dynamic information table 2000, the information on the status of the processing elements represented by the processing element numbers 2001 acquired at the registration times 2002 is contained in the processing element status 2003. The information on the status of the processing element includes the memory usage rate, the processing element usage rate, the electrical energy consumption, the CPU temperature, the input/output speed, and the number of sessions in execution. The information on the status of the processing element is represented by the values of the respective terms at the moment of the registration time 2002 or average values over a predetermined period of time in the past. In FIG. 6, the number of sessions in execution is shown as an example of the status of the processing element. The registration time is represented by the elapsed time from a reference time in milliseconds. Although the number of sessions in execution is indicated by a value at the moment of the registration time, it may be indicated by an average value in the past instead. The information on the other statuses of the processing element may also be represented by either a value at a moment or an average value.

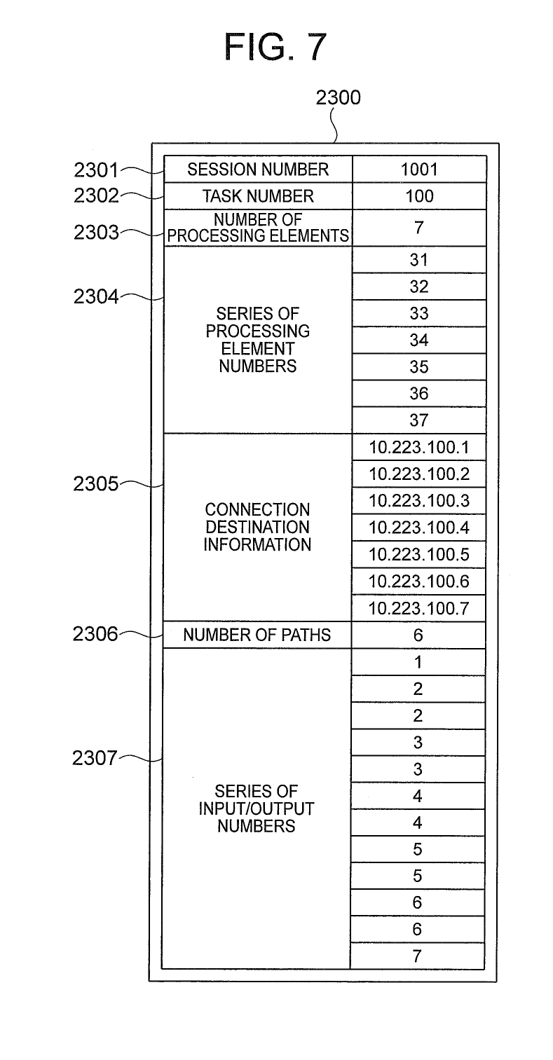

In the following, a description will be made of an exemplary configuration of processing path information with reference to FIG. 7. FIG. 7 is a processing path table 2300 in a case in which the JPEG decoding process is executed with the system configuration shown in FIG. 3.

The control unit 20 creates the processing path table 2300 based on the task configuration information and the processing element information. The control unit 20 sends the processing path table 2300 to the processing elements so as to dynamically select the processing elements and establish communication paths between the processing elements, thereby constructing a processing system.

The processing path table 2300 contains the session number 2301, the task number 2302, the number of processing elements 2303, a series of processing element numbers 2304, connection destination information 2305, the number of processing paths 2306, and a series of input/output numbers 2307. The session number 2301 is a number specific to each task processing, and if the same task is executed two or more times, different session numbers are assigned to the different task executions. A series of processing element numbers of the processing elements required for the execution of the task represented by the task number 2302 are sequentially stored in the series of processing element numbers 2304. The number of the processing elements is stored in the number of processing elements 2303.

In the series of input/output numbers 2307, the input and output at the end points of a path are represented by indices, like in the case of the task configuration table 2400 (FIG. 4), and the number of paths having the input and output is stored in the number 2306 of processing paths. In the case shown in FIG. 7, the session number is 1001. In the case where the JPEG decoding process is sequentially executed with the system configuration shown in FIG. 3, the session number changes, for example to 1002, 1003, . . . . If there is another processing element 39 that can provide the IDCT service designated by the service number 104 in the system shown in FIG. 1, another processing path table in which the processing element number 34 is replaced by the processing element number 39 may be created.

### First Embodiment

### (Configuration of Control Unit)

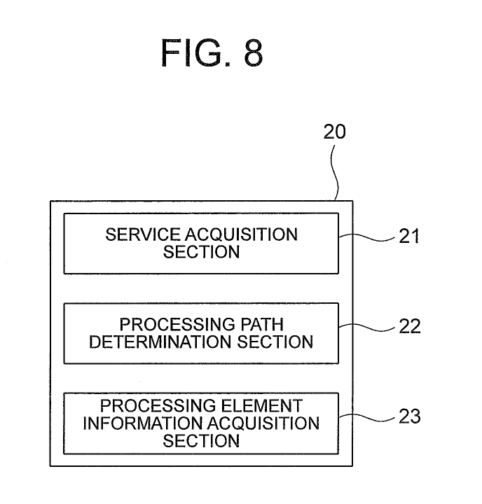

FIG. 8 is a diagram showing the internal configuration of a control unit 20 according to a first embodiment.

The control unit 20 includes three control modules, or a service acquisition section 21, a processing path determination section 22, and a processing element information acquisition section 23. The service acquisition section 21 analyzes a requested task and acquires information on the services that constitute the task using the task configuration information. The processing element information acquisition section 23 acquires static or dynamic information on the connected processing elements and manages them as the processing element information. The processing path determination section 22 determines the processing path information that defines the processing elements to be used in the distributed processing of the task and the processing paths between the processing elements, based on the task configuration information and the processing element information. The connection between the control modules may have any topology such as a bus topology, a ring topology, or a tree topology.

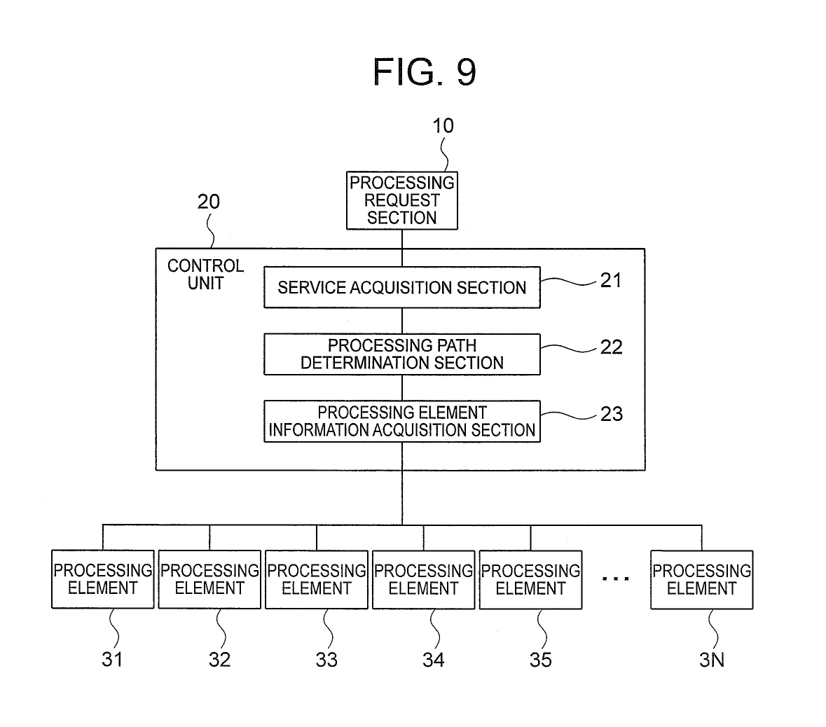

FIG. 9 is a diagram showing the configuration of the overall distributed processing system including the internal configuration of the control unit 20 according to the first embodiment. In the following, a description will be made of an exemplary system configured as a tree structure in which the service acquisition section 21 serves as an upper layer that communicates with the processing request section 10, the processing element information acquisition section 23 serves as a layer that communicates with the processing elements, and the processing path determination section 22 serves as an intermediate layer.

In the following, the control modules are described as software that runs on a general-purpose processor. However, the control module may be hardware such as an ASIC (Application Specific Integrated Circuit) that provides the same function or a reconfigurable processor in which the interconnections can be reconfigured in accordance with the function to be provided. Although in the following description it is assumed that the processing paths are established in a network using TCP/IP protocol (Transmission Control Protocol/Internet Protocol), the processing paths may be established in a network using other protocols. Furthermore, the processing paths may be established using buses such as AMBA (Advanced Microcontroller Bus Architecture) buses in the processor system or interface such as PCI (Peripheral Component Interconnect), serial ATA (Advanced Technology Attachment), or USB (Universal serial Bus).

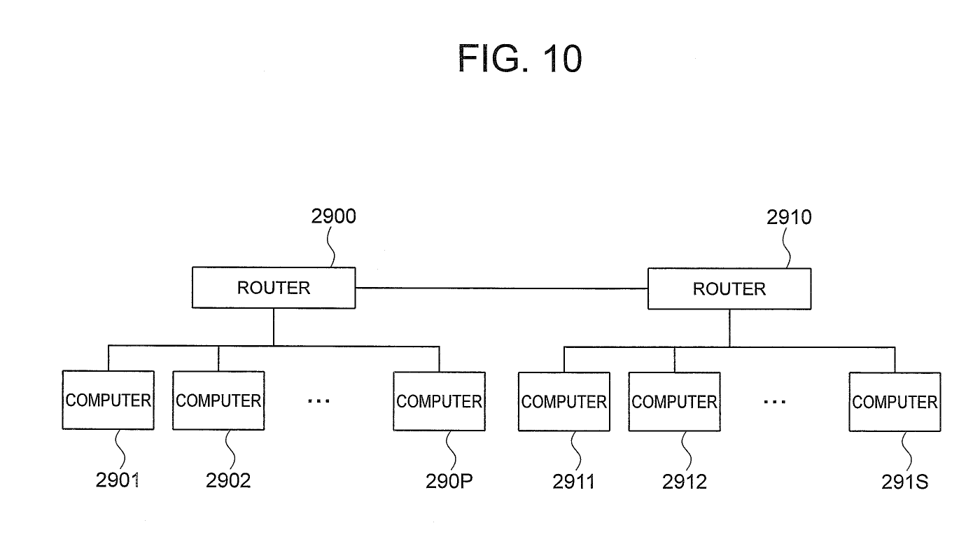

FIG. 10 is a diagram showing a physical network in which the control modules are assigned.

Computers 2901, 2902, 2903, . . . , and 290P are arranged sequentially on the same subnet on a router 9900. These computers have IP addresses different from each other. Similarly, computers 2911, 2912, 2913, . . . , and 2915 are arranged sequentially on the same subnet on a router 2910. These computers also have IP addresses different from each other. The last digits “P” and “S” of the reference numeral denoting the computers are natural numbers equal to or larger than 2 and equal to or smaller than the number of the computers that can be connected to the router.

The router 2900 and the router 2910 are connected to each other. In this embodiment, the computer 2901 causes the service acquisition section 21 to operate, the computer 2902 causes the processing path determination section 22 to operate, and the computer 2903 causes the processing element information acquisition section 23 to operate. The computers 2901, 2902, and 2903 have the IP addresses shown in FIG. 1. However, the control modules may be provided on the computers 2911, 2912, . . . , and 291S on a different subnet.

In all of the following embodiments, it is assumed that more than one control modules will not be provided on one computer, unless specifically stated otherwise.

TABLE 1

| name of Apparatus | IP Address |
|---|---|
| router 2900 | 192.168.100.1 |
| computer 2901 | 192.168.100.201 |
| computer 2902 | 192.168.100.202 |
| computer 2903 | 192.168.100.203 |

### (Processing Procedure)

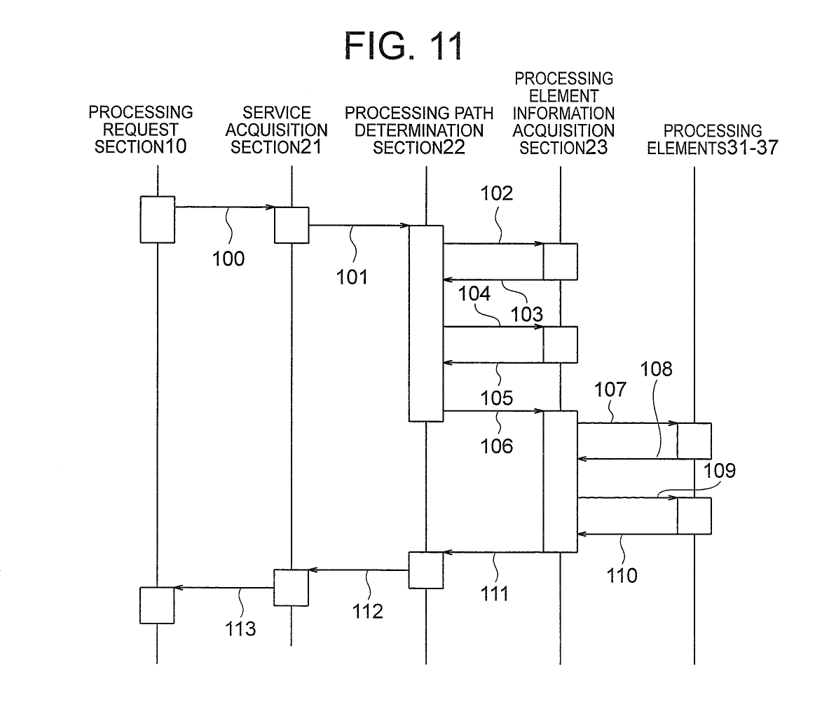

FIG. 11 is a diagram showing the order of processing in the JPEG decoding with the system configuration shown in FIG. 9. Here, for the sake of simplicity, it is assumed that the JPEG file to be decoded is present in the processing element 31, and the processing element 31 has already been notified of the name of the JPEG file to be decoded.

In step 100, the processing request section 10 sends the task number 100 of the JPEG decoding process as a processing request to the service acquisition section 21. The service acquisition section 21 extracts the corresponding series of service numbers and the information on the processing paths using the task configuration table 2400.

In step 101, the extracted information is sent to the processing path determination section 22. In step 102, the processing path determination section 22 transfers the extracted information to the processing element information acquisition section 23. In step 103, the processing element information acquisition section 23 determines the processing elements that can provide the services using the static information table 1900 (shown in FIG. 5), and returns the determination result to the processing path determination section 22.

In step 104, the processing path determination section 22 makes a request for the information on the status of the processing elements that can provide the services, to the processing element information acquisition section 23. This information is necessary for the determination of the processing path.

In step 105, the processing element information acquisition section 23 extracts the information on the status of the processing elements using the dynamic information table 2000 (shown in FIG. 6) and returns the extracted information to the processing path determination section 22. The processing path determination section 22 creates a processing path table 2300 based on the information on the status of the processing elements acquired in step 105 in accordance with a predetermined processing path determination method. The processing path determination method employed here is picking the processing elements having the smallest number of sessions in execution in ascending order of processing element number, and the processing path determination section 22 makes a request, in step 104, for information on the number of the services in execution in each of the processing elements acquired in step 103.

In step 106, the processing path determination section 22 sends the processing path table 2300 (shown in FIG. 7) to the processing element information acquisition section 23. In step 107, the processing element information acquisition section 23 sends the processing path table 2300 to all the processing elements 31, 32, 33, 34, 35, 36, 37 listed in the processing path table 2300. The processing elements receiving the processing path table 2300 establish the processing paths in the direction from the output side processing elements to the input side processing elements based on the processing path table 2300.

In step 108, a notification of the completion of the establishment of the processing path is sent to the processing element information acquisition section 23. After receiving the notification of the completion of the establishment of the processing path from all of the processing elements 31, 32, 33, 34, 35, 36, 37, the processing element information acquisition section 23 concludes that the data processing can be started and sends, in step 109, a process start request to the first processing element 31 in the processing path.

In step 110, after completing data processing, the processing elements send a notification of the completion of processing to the processing element information acquisition section 23. In step 111, after receiving the notification of the completion of processing from all of the processing elements 31, 32, 33, 34, 35, 36, 37, the processing element information acquisition section 23 sends a notification of the completion of processing to the processing path determination section 22.

In step 112, the processing path determination section 22 transfers the notification of the completion of processing to the service acquisition section 21. In step 113, the service acquisition section 21 transfers the notification of the completion of processing to the processing request section 10. Thus, the entire process is completed.

The method of establishing the connection between the control modules upon starting up the control modules may be:

(1) a method in which a master control module makes a request for connection to all the other control modules, and the slave control modules respond to the request, thereby establishing the connection; or
(2) a method in which a master control module directly establishes the connection with a slave control module with fixed connection destination information, without making a request for connection to all the other control modules.

Either (A) a control module in the upper layer or (B) a control module in the lower layer in each connection is set to be a master module.

In the case where the control module in the upper layer serves as the master control module, (i) the service acquisition section 21 serves as a master control module, and the processing path determination section 22 serves as a slave control module, or (ii) the processing path determination section 22 serves as a master control module and the processing element information acquisition section 23 serves as a slave control module.

The setting of master/slave relationship of the control modules can be executed employing the above method not only at the start-up of the system but also at the time when a control module is rebooted as is the case with the processing path determination section 22 when the processing path determination method has been changed. In this case, the master control module may be (C) the rebooted control module.

The control modules hold their mutual connection relationship as distributed controller connection information to specify the master/slave relationship between the control modules. Table 2 shows a control module connection table of the processing path determination section 22 in the system having hierarchical structure shown in FIG. 9, as an exemplary configuration of the distributed controller connection information. The control module connection table may be either fixed information held in the control module or rewritable information that can be rewritten by a user from outside of the control module.

TABLE 2

| master | slave |
|---|---|
| service acquisition section 21 | processing path determination |
| | section 22 |
| processing path determination | processing element |
| section 22 | information acquisition |
| | section 23 |

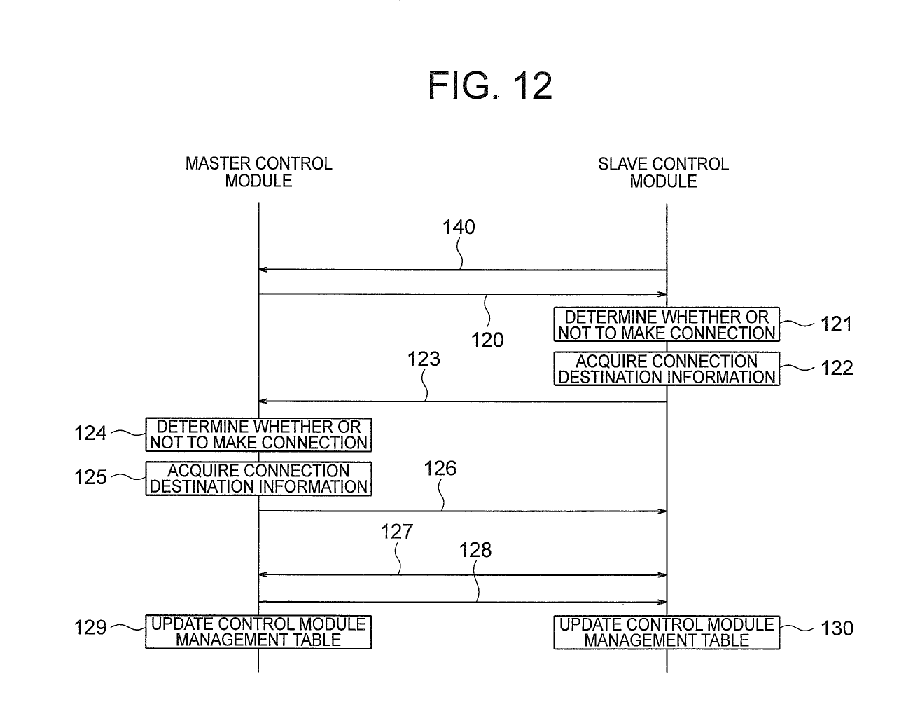

FIG. 12 is a chart of a start-up sequence of the control modules according to the first embodiment. FIG. 12 shows a basic start sequence with method (1), or the method in which the master control module makes a request for connection to all the other control modules, and the slave control modules respond to the request, thereby establishing connections. In the process described here, the connections between the control modules are established using method (1).

In step 140, the slave control module notifies its own module number to all the other control modules after start-up. However, if the slave control module receives a connection request made in step 120 (which will be described later) before step 140, the slave control module need not make this notification. This notification will be referred to as the “start-up notification”. The module number mentioned above will be discussed later. If the master control module makes a connection request to all the other control modules repeatedly at regular intervals, the step of making the start-up notification by the master module may be eliminated even if the slave control module starts after the start-up of the master control module.

In step 120, the master control module makes a request for connection to all the control modules. It is assumed that the information on the connection destinations of the control modules that receive the connection request has already been known. The master control module sends control module information together with the connection request.

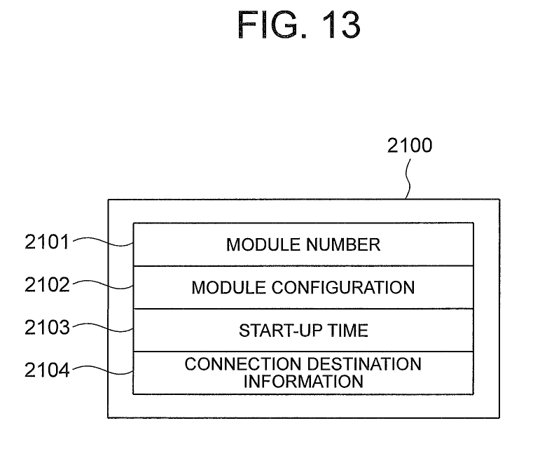

Here, a description will be made of the control module information. FIG. 13 is a table showing an exemplary configuration of the control module information.

The control module information 2100 contains the module number 2101, the module configuration 2102, the start-up time 2103, and the connection destination information 2104. The module number 2101 is a number specific to each control module. Each control module holds its own module number.

The module configuration 2102 is information on the module configuration such as a hardware architecture, an OS, and a memory capacity. The start-up time 2103 is the start-up time of the control module corresponding to the module number 2101. The connection destination information 2104 is information on the destination of connection used for communication of control information with a control module to communicate with. The connection destination information 2104 includes, for example, an IP address, a port number, and a channel number. The connection destination information may be determined at the time of execution. Alternatively, it may be fixed information. The connection destination specified by the connection destination information need not be the same connection destination of the connection request made to establish the connection between the control modules.

In step 121, in response to the connection request made from the master control module, the slave control module determines whether or not to make a connection to the master control module. The slave control module makes this determination by determining whether or not the master control module is in a connection relationship with the slave control module itself based on the control module connection table and the received control module information 2100. For example, in the system shown in FIG. 9, the processing element information acquisition section 23 receives a connection request from the service acquisition section 21, but the processing element information acquisition section 23 determines that it is not necessary to make a connection to the service acquisition section 21.

In step 122, the slave control module acquires information of own connection destination in the slave control module to which the master control module is to make a connection.

In step 123, the slave control module returns a connection response to the master control module. The connection response includes the connection destination information acquired in step 122. The connection response also includes the control module information 2100 of both of the master control module and the slave control module. It is assumed that the connection destination information of the receiving side of the connection response has already been known. This connection destination information is, as with the connection destination information used in the communication of the connection request, used to establish the connection between the control modules, and it may be different from the connection destination information used for communication of the control information.

In step 124, the master control module determines whether or not to make a connection to the slave control module. The master control module makes this determination by determining whether or not the slave control module is in a connection relationship with the master control module based on the control module connection table and the received control module information 2100.

In step 125, the master control module acquires information of own connection destination in the master control module to which the slave control module is to make a connection.

In step 126, the master control module makes a connection to the slave control module using the connection destination information of the slave control module acquired in step 123.

In step 127, a communication channel for communicating the control information between the master control module and the slave control module is established.

In step 128, the master control module sends its own control module information to the slave control module.

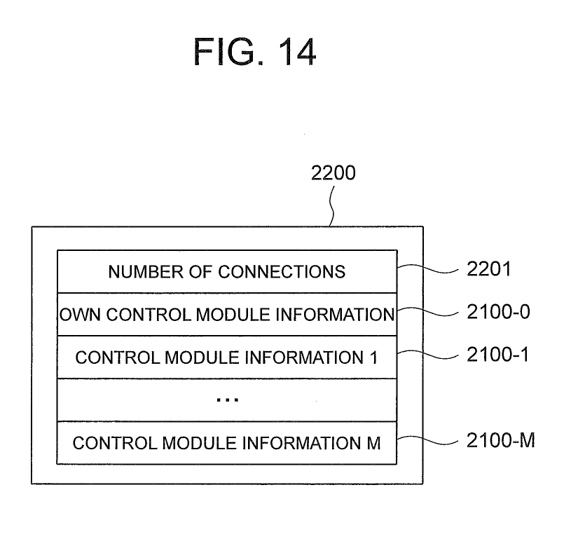

In step 129, the master control module updates a control module management table based on the information on the slave control modules to manage the information on the control modules connected to the master control module. FIG. 14 is a table showing an exemplary configuration of the control module management table. The control module management table 2200 contains the number of connections 2201 indicating the number M of control modules connected to the master control module and control module information 2100-0, 2100-1, . . . , 2100-M including the control module information 2100-0 of the master control module itself, where M is a natural number. More specifically, in step 129, the master control module adds control module information to the control module table, and updates the number of the connections in the control module management table.

In step 130, the slave control module also updates the control module information in the control module management table.

In the case of method (2), or the method in which the master control module directly establishes the connection between the slave control module with fixed connection destination information, without making a request for connection to all the other control modules, the master control module, for example, sets the connection destination in the slave control module into a standby state waiting for connection in advance and directly makes a connection to the slave control module to exchange the control module information. The method of establishing a connection between the control modules is not limited to the above described methods (1) and (2). Any other method of establishing a connection between the optional control modules to allow exchanging of control module information may be employed.

If the connection between the modules is disconnected due to a failure in the communication channel, a reconnection process may be executed using the control module management table shown in FIG. 14. Here, it is assumed that the control modules have no failure.

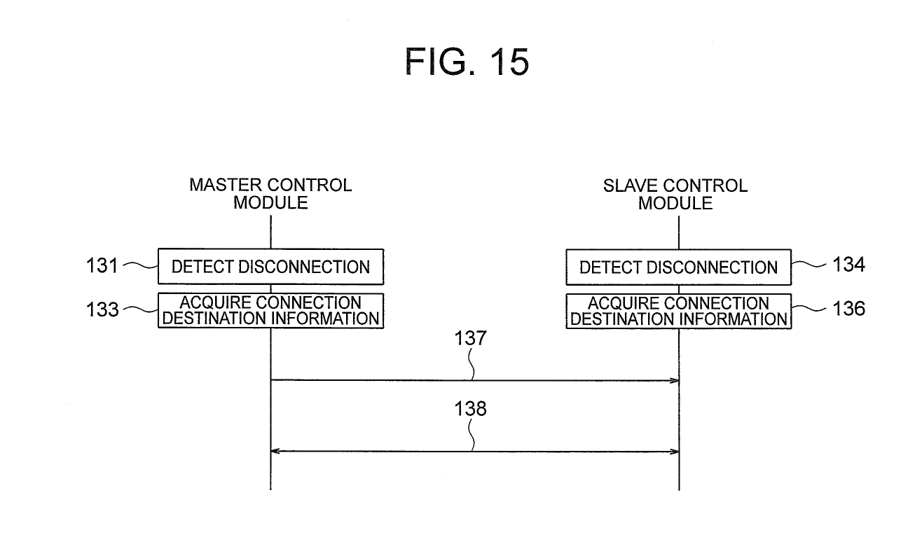

The reconnection process will be described with reference to FIG. 15. FIG. 15 is a chart of a sequence of the reconnection of the control modules.

In step 131, the master control module detects a disconnection of the slave control module. For example, the simplest way of detecting the disconnection of the slave control module is detecting the failure in data transmission.

In step 133, the master control module specifies the connection destination in the slave control module based on the control module management table. In step 134, the slave control module detects the disconnection of the master control module simultaneously with step 131.

In step 136, the slave control module specifies the connection destination in the master control module based on the control module management table. Then, the slave control module waits for a connection from the master control module.

In step 137, the master control module makes a connection to the slave control module.

In step 138, the master control module establishes a communication channel for communicating control information with the slave control module again.

In the reconnection sequence shown in FIG. 15, most part of the sequences shown in FIG. 12 can be eliminated when establishing a connection again by using the control module management table.

### (Operations and Advantages)

Operations and advantages of the control unit 20 (distributed controller), the distributed processing system, and the distributed processing method using the control unit 20 and distributed processing system according to the first embodiment will be described.

A case in which the processing path determination section 22 is replaced by a processing path determination section that can provide another processing path determination method, or a case in which the computer on which the processing path determination section runs becomes unavailable will be discussed. When the control modules are implemented as software, the replacement of the processing path determination section involves the reboot of the module or the reboot of the computer. When the control modules are implemented as hardware, the reboot of the chip is necessary. When the computer needs to be rebooted, if all the control modules run on the same computer, all the control modules need to be rebooted.

On the other hand, in the distributed controller and the distributed control system according to the first embodiment, the control modules are assigned on different computers, and the control modules can be started in random order in accordance with the distributed controller connection information and connection requests. Therefore, since only the processing path determination section 22 can be updated, and only the computer 2902 can be rebooted. Thus, the overall system is not affected by the updating. This improves the maintainability. Only the updated control module can be rebooted without rebooting the computer. This improves the maintainability.

When a communication error occurs between the control modules, the control modules can make a reconnection using the control module management table 2200. The control modules can be automatically reconnected in the case of a temporary communication error or the like in which the reboot is not necessary. This improves the maintainability.

The control modules can run both in the case where a plurality of control modules are assigned on the same computer and in the case where all the control modules are assigned on the same computer. Even in the case where a plurality of control modules are assigned on the same computer, each of the control modules can be maintained individually, and the improvement in the maintainability can be achieved. However, all the control modules become unavailable if the computer itself becomes unavailable. Therefore, all the control modules have been described to be assigned on different computers.

### Second Embodiment

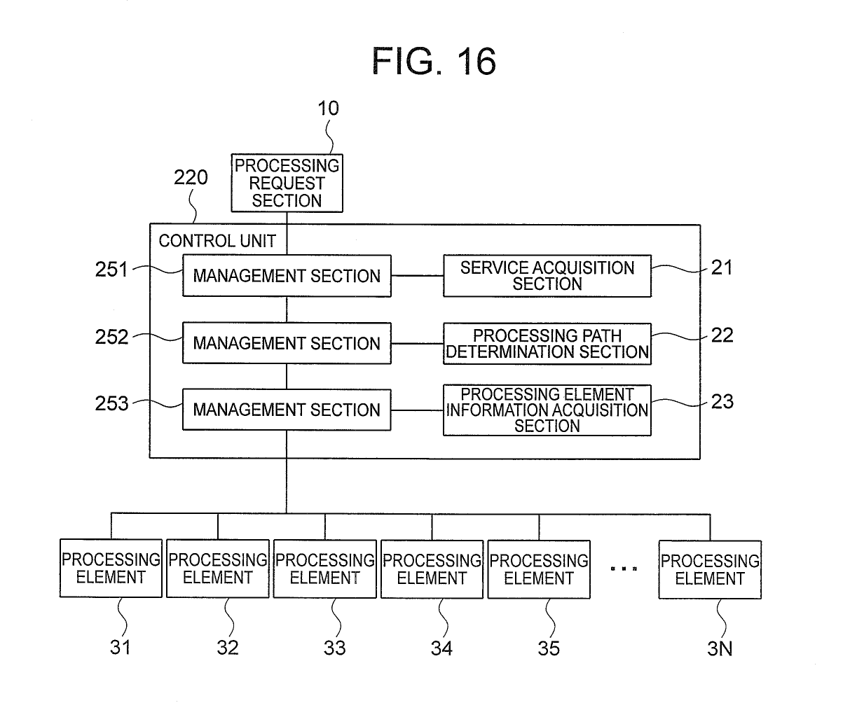

FIG. 16 is a diagram showing the basic overall configuration of a distributed processing system as well as the internal configuration of a control unit 220 (distributed controller) according to a second embodiment.

The control unit 220 includes as control modules a service acquisition section 21, a processing path determination section 22, and a processing element information acquisition section 23 and also includes management sections 251, 252, 253 that manage the function and condition of the control modules. The management sections are defined as special control modules. Here, different management sections are provided for the respective control units according to their functions. Specifically, the management section 251 manages the service acquisition section 21, the management section 252 manages the processing path determination section 22, and the management section 253 manages the processing element information acquisition section 23.

Table 3 shows a configuration of an extended module number. Although the maximum number of connections may be defined individually according to the types of the control modules, in the case described in the following all the control modules are assumed to have the same maximum number of connections. The management section flag, the function type, the function number are determined according to the functions that the control modules provide, and they are stored in the control modules. The maximum number of connections may either be held internally or set externally by a user etc. The serial number may either be held internally or determined at the time of execution. Control modules providing the same function should be prevented from having the same serial number.

TABLE 3

| | | |
|---|---|---|
| management section | 0 | control module other than |
| flag | | management section |
| | 1 | management section |
| type of function | 1 | acquiring service |
| | 2 | determining processing path |
| | 3 | acquiring processing |
| | | element information |
| function number/ | M (M: | M is the function number for |
| maximum number of | integer) | management section flag of |
| connections | | 0, and the maximum number of |
| | | connections for management |
| | | section flag of 1. The |
| | | function number specifies |
| | | the function provided by a |
| | | control module other than |
| | | the management sections. |
| | | For example, processing |
| | | path determination sections |
| | | having different processing |
| | | path determination methods |
| | | are given function numbers |
| | | different from each other. |
| | | The maximum number of |
| | | connections is the maximum |
| | | number of control modules |
| | | connectable to a management |
| | | section. “M = 0” represents |
| | | that there is no limit on the |
| | | number of connections. |
| serial number | P (P: | Serial numbers added to |
| | natural | control modules including |
| | number) | management sections that |
| | | provide the same function. |

In the following description, the module number is represented in the style of “management section flag-function type-function number/maximum number of connections-serial number”. Table 4 shows the numbers given to the control modules shown in FIG. 16.

For example, a management section for the service acquisition section having the maximum number of connections of 4 that starts up first to be given a serial number of 0 will have a module number of 1-1-4-0.

Undefined numbers will be represented by “X”. For example, a module that is not given a serial number is represented by 0-2-1-X etc.

Furthermore, a set of the control modules will also be represented by X. For example, a module number 0-2-X-X represents a set of the processing path determination sections that are not management sections.

TABLE 4

| | |
|---|---|
| service acquisition section | 0-1-X-X |
| management section for service | 1-1-X-X |
| acquisition section | |
| processing path determination | 0-2-X-X |
| section | |
| management section for | 1-2-X-X |
| processing path determination | |
| section | |
| processing element | 0-3-X-X |
| information acquisition | |
| section | |
| management section for | 1-3-X-X |
| processing element | |
| information acquisition | |
| section | |

The control modules in the system shown in FIG. 16 holds the control module connection table shown in table 5 as distributed controller connection information, in which the master control modules and the slave control modules are defined by module numbers.

TABLE 5

| master | slave |
|---|---|
| 1-1-X-X | 1-2-X-X |
| 1-2-X-X | 1-3-X-X |
| 0-1-X-X | 1-1-X-X |
| 0-2-X-X | 1-2-X-X |
| 0-3-X-X | 1-3-X-X |

The master control module shown in Table 5 send control module information to all the control modules to make a request for connection in accordance with the start-up sequence shown in FIG. 12. Each slave control module establishes a connection in response to the connection request from the master control module and exchanges the control module information with the master control module. In the case where the connection destination information is fixed, the slave control module directly establishes a connection with the master control module.

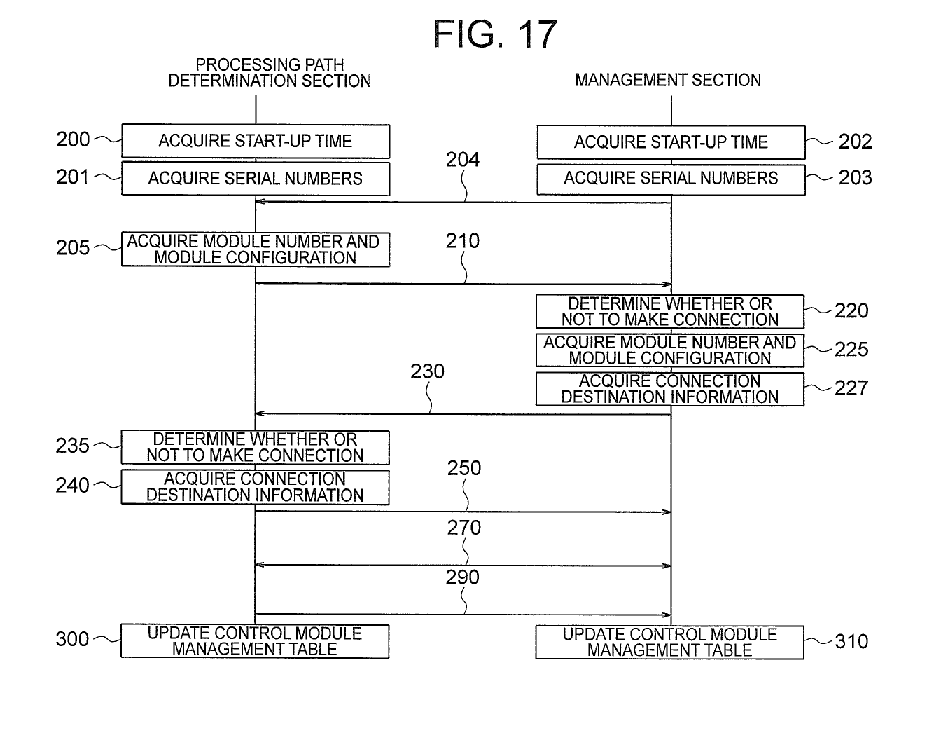

FIG. 17 is a chart of a connection sequence in a case where the processing path determination section 22 serves as a master control module and the management section 252 serves as a slave control module. The processing path determination method of the processing path determination section 22 is represented by a function number of 1111. The maximum number of connections of the management section 252 is assumed to be 4.

In step 200, the processing path determination section 22 acquires the start-up time. The processing path determination section 22 may acquire the start-up time using a GPS (Global Positioning System) or an NTP (Network Time Protocol) server. Alternatively, a clock may be held in common in the system. Here, the start-up time is represented as the difference from a reference time in milliseconds, which is assumed, in this case, to be equal to 100.

In step 201, the processing path determination section 22 performs arbitration of serial numbers and determines the serial numbers. It is assumed here that the other processing path determination sections are not running, and a serial number of 0 is given to the processing path determination section 22. For example, a token held among the processing path determination sections may be used, and when the processing path determination section 22 gets the token, the processing path determination section 22 collects the serial numbers of the active processing path determination sections. The processing path determination section 22 gives an unused serial number to itself and then releases the token.

The management section 252 also acquires the start-up time and performs arbitration of serial numbers in steps 202 and 203 as with steps 200 and 201 for the processing path determination section 22. The start-up time of the management section 252 is assumed to be equal to 101, and the serial number of the management section 252 is assumed to be 0.

In step 204, the management section 252 sends a start-up notification to all the other control modules. If the management section 252 receives a connection request from the processing path determination section 22 before sending the start-up notification, step 204 may be skipped.

In step 205, the processing path determination section 22 acquires the module number and the module configuration as its own control module information. The connection destination information has not been determined yet.

In step 210, the processing path determination section 22 sends the control module information to all the control modules including the management section 252 to make a request for connection. The connection destination information of the management section 252 that receives the connection request is shared by the entire system, and the management section 252 also receives connection requests from the control modules other than the processing path determination section 22.

In step 220, upon receiving the connection request from the processing path determination section 22, the management section 252 determines whether or not to make a connection based on the control module connection table. The management section 252 checks that the number of connections in the connection management information is lower than the maximum number of connections of 4, and determines to make a connection to the processing path determination section 22.

In step 225, the management section 252 acquires the module number and the module configuration as its own control module information. In step 227, the management section 252 determines the connection destination information. For example, the IP address and the port number are determined as 192.168.100.252:50022. Then, the management section 252 waits for a connection from the processing path determination section 22 at the connection destination acquired in step 227.

In step 230, the management section 252 sends the control module information as a response to the processing path determination section 22. The response contains the control module information of the processing path determination section 22 received in step 210.

In step 235, the processing path determination section 22 checks whether or not the management section 252 is defined as a connection destination based on the control module connection table to determine whether or not to make a connection.

In step 240, the processing path determination section 22 acquires its own connection destination information to which the management section 252 is to make a connection. For example, the IP address and the port number are determined as 192.168.100.22:50252.

In step 250, the processing path determination section 22 makes a connection to the management section 252 based on the connection destination information of the management section 252 acquired in step 230 and the connection destination information of its own acquired in step 240.

In step 270, the connection between the processing path determination section 22 and the management section 252 is established.

In step 290, the processing path determination section 22 sends the connection destination information to the management section 252.

In step 300, the processing path determination section 22 adds the control module information about the management section 252 to the control module management table 2200 and updates the number of connections.

In step 310, as with step 300, the management section 252 adds the control module information about the processing path determination section 22 to the control module management table 2200 and updates the number of connections.

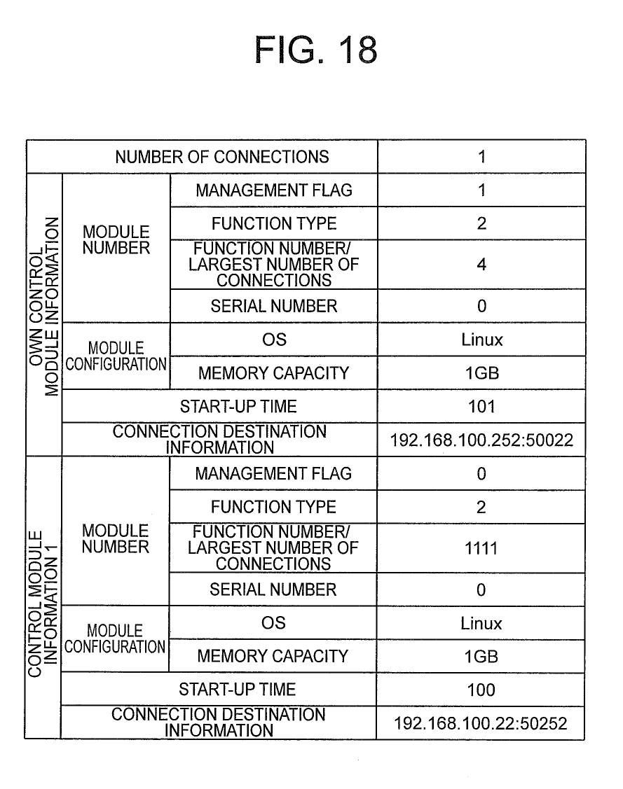

FIG. 18 is a table showing the control module information held by the management section 252 after completion of the entire sequence shown in FIG. 17. The connections between the management sections are not shown in FIG. 18.

The first information in this table is the number of connected modules. The number of connected modules is 1 in the illustrated case. Subsequent to this is the control module information arranged in order of connection. The first control module information is the control module information of its own, which is succeeded by the control module information of the processing path determination section 22 connected thereto. The control module information of the connected processing path determination section 22 is held as control module information 1.

Both in the case where the management section 251 serves as a master and the management section 252 serves as a slave and in the case where the management section 252 serves as a master and the management section 253 serves as a slave, a sequence similar to the sequence shown in FIG. 17 is executed to exchange the control module information and update the control module management table 2200. When a control module is added, the control module management table 2200 is updated by adding the control module information of its own and the control module information of the control module to which a connection is made and incrementing the number of connections. When a control module is disconnected, the control module management table 2200 is updated by deleting the control module information of the disconnected control module and decrementing the number of connections.

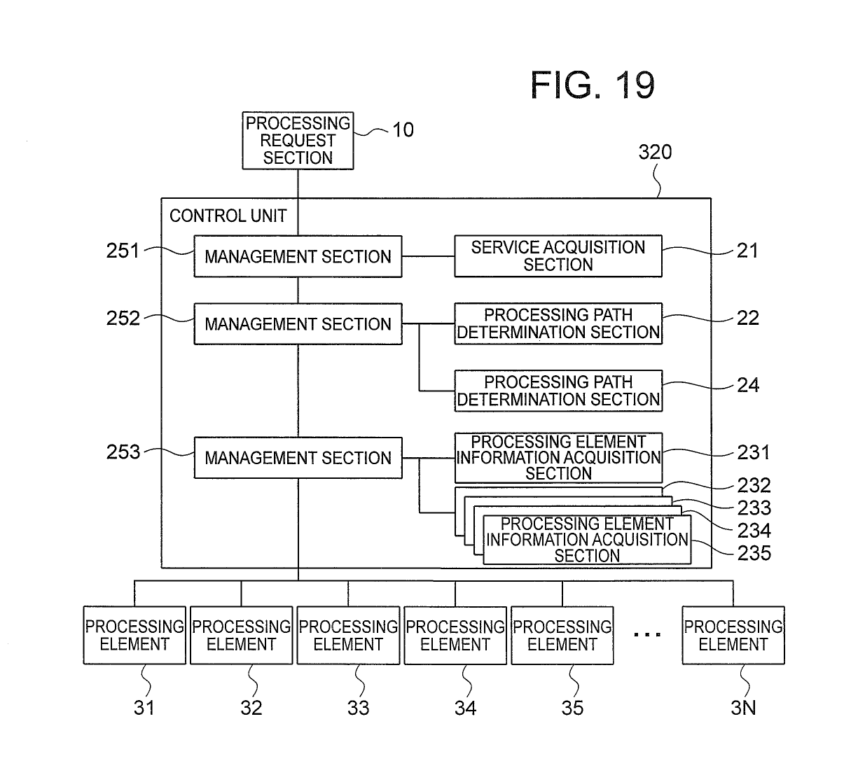

A description will be made of a case where a processing path determination section 24 is newly activated and added to the system shown in FIG. 18. FIG. 19 shows the basic configuration of the overall distributed processing system including the internal configuration of the extended control unit 320.

In the control unit 320 (distributed controller) shown in FIG. 19, six control modules, or a processing path determination section 24 and processing element information acquisition sections 231, 232, 233, 234, and 235, are added to the control unit 220 shown in FIG. 16.

The processing path determination method of the processing path determination section 24 is represented by a function number of 2222. The processing path determination section 24 also makes a connection to the management section 252 in accordance with the sequence shown in FIG. 17. The serial number acquired in step 201 is 1 because the processing path determination section 22 has already been active.

Furthermore, in step 227, the management section 252 provides connection destination information different from that sent to processing path determination section 22 to the processing path determination section 24. For example, the IP address and the port number are determined as 192.168.100.252:50024. The responses sent to the processing path determination section 24 in step 230 and subsequent steps are distinguished from the responses to the other processing path determination section 22 by the serial number. Therefore, the processing path determination section 24 may provide a processing path determination method represented by the same function ID 1111 as the processing path determination section 22.

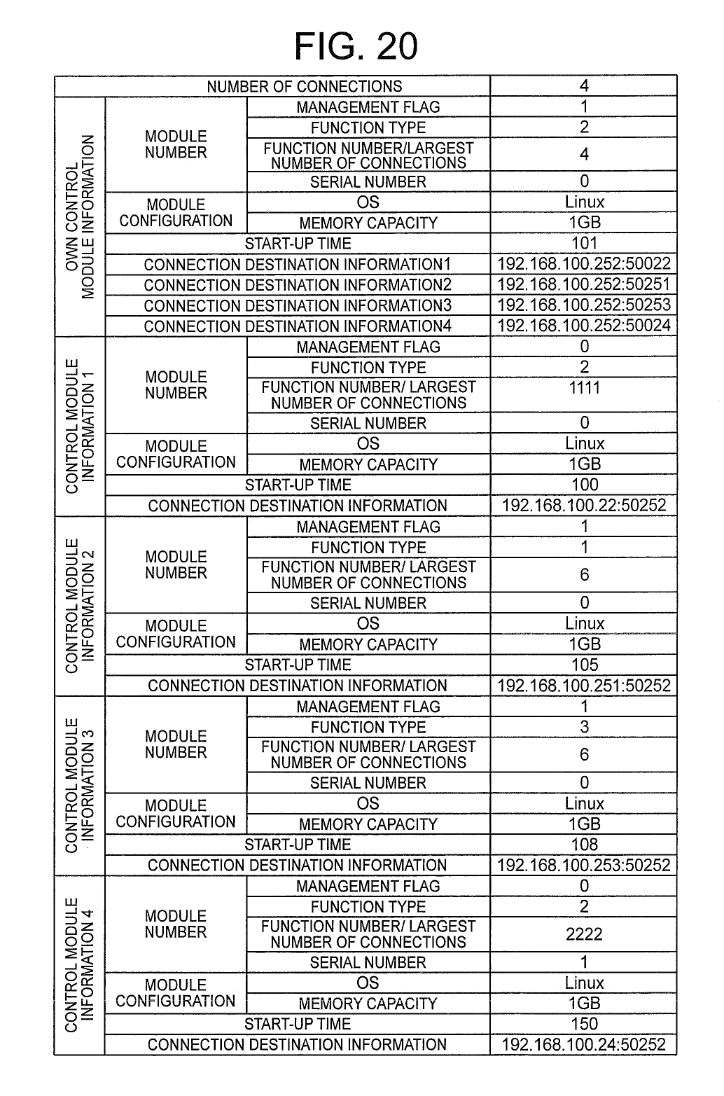

FIG. 20 shows a control module management table of the management section 252 after the connection of the processing path determination section 24 thereto. The control module management table contains the control module information for the control modules 1 to 4, or the processing path determination section 22, the management section 251, the management section 253, and the processing path determination section 24 in addition to its own control module information.

On the other hand, in the distributed processing system shown in FIG. 19, the processing element information acquisition section 23 is divided into five sections, or a processing element information acquisition section 231 for acquiring static information and processing element information acquisition sections 232, 233, 234, and 235 for acquiring dynamic information. These five processing element information acquisition sections are managed by the management section 253. For example, as the dynamic information, the processing element information acquisition section 232 acquires the memory usage rate, the processing element information acquisition section 233 acquires the electrical energy consumption, the processing element information acquisition section 234 acquires the data input/output speed, and the processing element information acquisition section 235 acquires the number of sessions in execution.

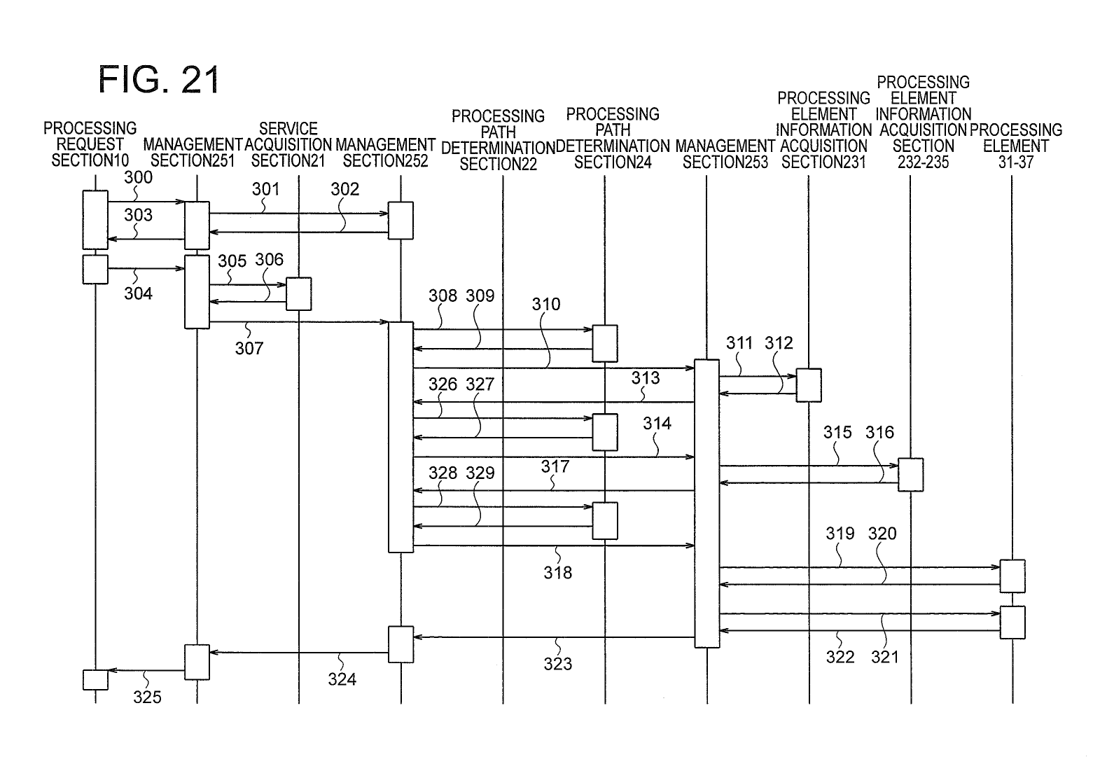

FIG. 21 is a chart showing the order of processing in the JPEG decoding with the system configuration shown in FIG. 19. For the sake of simplicity, it is assumed that the JPEG file to be decoded is present in the processing element 31, and the processing element 31 has already been notified of the name of the JPEG file to be decoded.

In step 300, the processing request section 10 sends information specifying the processing path determination method to the management section 251 as a selection condition. For example, the processing request section 10 sends information containing the function ID of the processing path determination section 24.

In step 301, the management section 251 transfers the selection information to the management section 252. The management section 252 sets the selection condition and returns, in step S302, a notification of the completion of setting to the management section 251.

In step 303, the management section 251 transfers the notification of the completion of setting to the processing request section 10.

Through steps 300 to 303, the selection condition for selecting the processing path determination section is set in the management section 252. Although the selection condition is described to be specified by the processing request section 10, it may be automatically determined in the system at the time of execution based on, for example, the status of the processing elements acquired through the processing element information acquisition sections 231, 232, 233, 234, 235. Alternatively, the selection condition may be held in the management section 252 as fixed information.

In step 304, the processing request section 10 sends the task number 100 of the JPEG decoding process to the management section 251 as a processing request. Since the service acquisition section 21 is the only control module other than the management sections that is connected to the management section 251, the management section 251 selects the service acquisition section 21 and sends the task number to it in step 305.

In step 306, the service acquisition section 21 extracts the corresponding service numbers and information about the processing paths using the task configuration table 2400. Then, the service acquisition section 21 sends the extracted information to the management section 251.

In step 307, the management section 251 transfers the extracted information to the management section 252.

In step 308, the management section 252 selects a processing path determination section based on the selection condition previously set in steps 300 to 303. In the case described here, the service numbers and the information on the processing paths are sent to the processing path determination section 24. In this case, the processing path determination section 22 is not used. However, the processing path determination method can be changed flexibly by changing the selection condition.

The processing path determination section 24 selects the static processing element information necessary for the determination of the processing paths. In step 309, the processing path determination section 24 returns a request for acquisition of the static processing element information of the processing elements that can provide the services to the management section 252.

In step 310, the management section 252 transfers the acquisition request to the management section 253.

In step 311, the management section 253 selects a processing element information acquisition section 231 that can acquire the static processing element information, based on the acquisition request and transfers the acquisition request to the selected processing element information acquisition section 231.

In step 312, the processing element information acquisition section 231 acquires the static processing element information requested by the processing path determination section 24 based on the static information table 1900 and returns it to the management section 253. The processing element information acquisition section 231 acquires the static processing element information when the processing elements 31, 32, 33, 34, 35, 36, 37, . . . 3N start and updates the static information table.

In step 313, the management section 253 transfers the static processing element information to the management section 252. In step 326, the management section 252 selects the processing path determination section 24 again and transfers the static processing element information to it. The processing path determination section 24 has determined the dynamic processing element information necessary for the determination of the processing paths. In this embodiment, the number of sessions in execution is acquired as the dynamic processing element information. Available processing elements are selected based on the static processing element information sent from the processing element information acquisition section 231.

In step 327, the processing path determination section 24 sends an acquisition request of the dynamic processing element information, which has been determined previously, of the selected processing elements to the management section 252.

In step 314, the management section 252 transfers the acquisition request to the management section 253. The management section 253 selects a dynamic processing element information acquisition section 235 that can acquire the number of sessions in execution.

In step 315, the management section 253 transfers the acquisition request to the dynamic processing element information acquisition section 235. The dynamic processing element information acquisition section 235 acquires the number of sessions in execution in selected processing elements based on the dynamic information table 2000. The dynamic processing element information acquisition sections 232, 233, 234, 235 can acquire the processing element information from the processing elements at any timing to update the dynamic information table 2000.

In step 316, the dynamic processing element information acquisition section 235 sends the acquired dynamic processing element information to the management section 253.

In step 317, the management section 253 transfers the dynamic processing element information to the management section 252. In step 328, the management section 252 selects the processing path determination section 24 again and transfers the acquired dynamic processing element information to it. The processing path determination section 24 selects processing elements based on the acquired dynamic processing element information and determines the paths between the processing elements to create the processing path table 2300.

In step 329, the processing path determination section 24 sends the processing path table thus created to the management section 252.

In step 318, the management section 252 transfers the processing path table 2300 to the management section 253.

In step 319, the processing path table 2300 is sent to all the processing elements 31, 32, 33, 34, 35, 36, and 37 listed in the processing path table 2300. The processing elements establish the processing paths in the direction from the output side processing elements to the input side processing elements based on the processing path table 2300.

In step 320, the processing elements send a notification of the completion of the establishment of the processing path to the management section 253. After receiving the notification of the completion of the establishment of the processing path from all the processing elements 31, 32, 33, 34, 35, 36, 37, the management section 253 concludes that the data processing can be started.

In step 321, the management section 253 sends a process start request to the first processing element 31 in the processing path.

In step 322, after completing data processing, the processing elements send a notification of the completion of processing to the management section 253.

In step 323, after receiving the notification of the completion of processing from all the processing elements 31, 32, 33, 34, 35, 36, 37, the management section 253 sends a notification of the completion of processing to the management section 252.

In step 324, the management section 252 transfers the notification of the completion of processing to the management section 251.

In step 325, as with step 324, the management section 251 transfers the notification of the completion of processing to the processing request section 10. Thus, the entire process is completed.

### (Operations and Advantages)

In the distributed processing system according to the second embodiment, the management section 252 manages the function and the connection state of a plurality of processing path determination sections as the control module management table, and different processing path determination sections can be used in accordance with selection conditions. This eliminates the need of rebooting, and allows each algorithm to be maintained independently. This improves the maintainability. The processing path determination section 22 and the processing path determination section 24 may provide the same function. The provision of a plurality of processing path determination sections enables the system to operate even when one of the processing path determination sections becomes unavailable. This improves the maintainability. The function provided by one of the processing path determination section can be solely maintained or updated.

As different types of information are managed by different control modules like in the case of the processing element information acquisition sections 231, 232, 233, 234, and 235, the information to be managed by each control module is limited. This eliminates the need of complicated processing or management of a large amount of information. Thus, the maintainability is improved. Different processing path determination methods require different kinds of processing element information. Therefore, if the processing element information acquisition section is divided finely into different processing element information acquisition sections respectively for different kinds of processing element information to be acquired, they can be used flexibly in various combinations. Furthermore, if a new kind of processing element information needs to be acquired, a control module specialized to the acquisition of the new kind of processing element information can be solely added to the system while it is operating. Therefore, the system can be extended at a small cost, the development of the system is easy, and the maintainability of the system is improved.

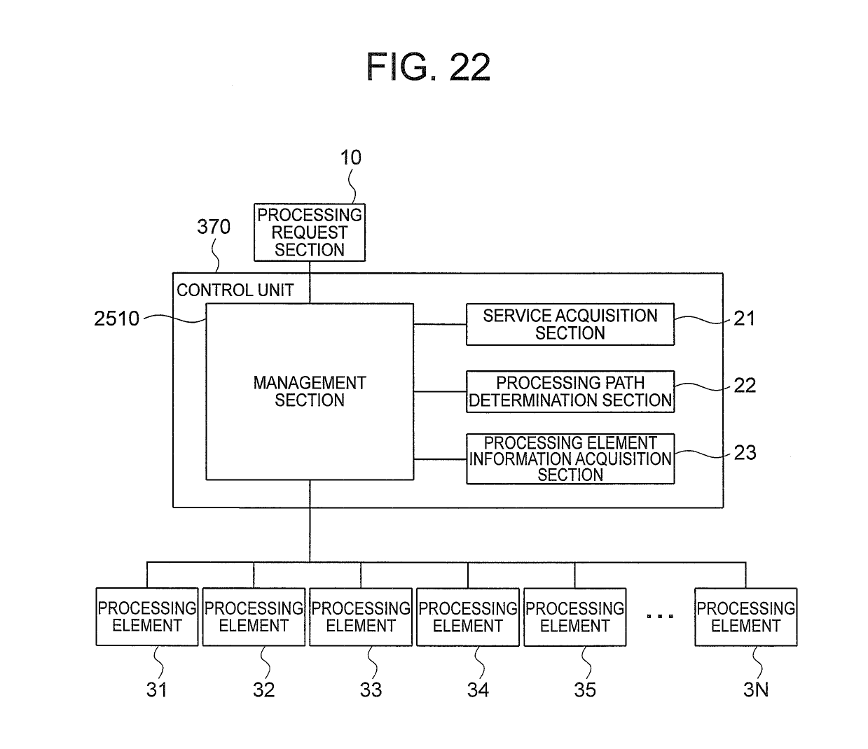

In the above described embodiment, the control modules are categorized according to their functions or the kinds of acquired information, and management sections are provided for the respective categories of control modules. However, if a cross-sectional management of the control modules is desired, a collective management of control module information with a reduced number of management sections may be employed. FIG. 22 is a diagram showing the configuration of a distributed processing system including a control unit 370 in which management sections are integrated into only one management section. The integrated management section 2510 makes a determination for all the control modules as to which processes are to be assigned to which control modules and selects the control modules.

Alternatively to the configuration shown in FIG. 22, two management sections 252, 253 that communicate frequently with each other as will be seen from FIG. 21 may be integrated into one management section to make the communication internal. Furthermore, the management section 251 that executes only a small amount of processing may be integrated into the management section 252 unless it makes the maintenance of the integrated management section 252 complex.

The configurations, operations and advantages other than those described above are the same as those of the above described embodiments.

### Third Embodiment

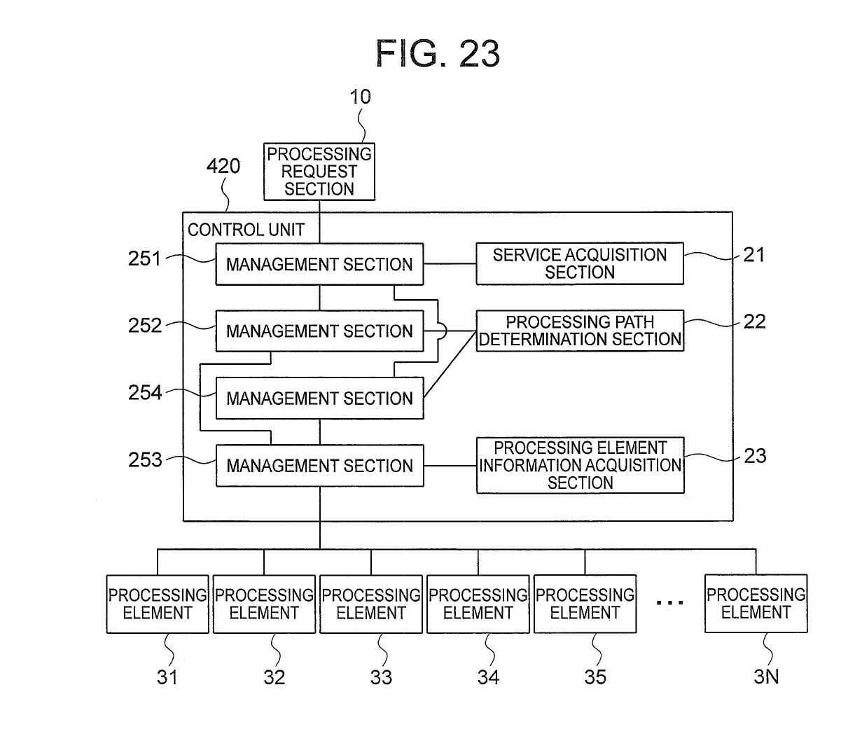

FIG. 23 is a diagram showing the overall configuration of a distributed processing system as well as the internal configuration of a control unit 420 according to a third embodiment.

In the control unit 420 (distributed controller) of the distributed processing system shown in FIG. 23, a management section 254 has been added to the control unit 220 shown in FIG. 16. The management section 254 is a control module that manages the processing path determination section 22 as with the management section 252. The management section 254 is connected to the management section 251, the management section 253, and the processing path determination section 22.

The management section 254 starts in accordance with the sequence shown in FIG. 12. It is assumed that the control modules of the control unit 420 make connections with each other in accordance with the control module connection table shown in Table 5.

The distributed processing system shown in FIG. 23 executes processing in accordance with the sequence shown in FIG. 21. However, the management section 251 selects either the management section 252 or the management section 254 to perform the communication in step 307. The same selection condition is applied to the entire system at least in processing a task having the same session number, and when the management section 253 performs communication in steps 313, 317, and 323 of FIG. 21, the management section 253 selects as the destination of the communication the management section same as that in step 307. For example, the management section having the earlier start-up time is selected. Similarly, the processing path determination section 22 and the management sections 251, 253 also select the same management section.

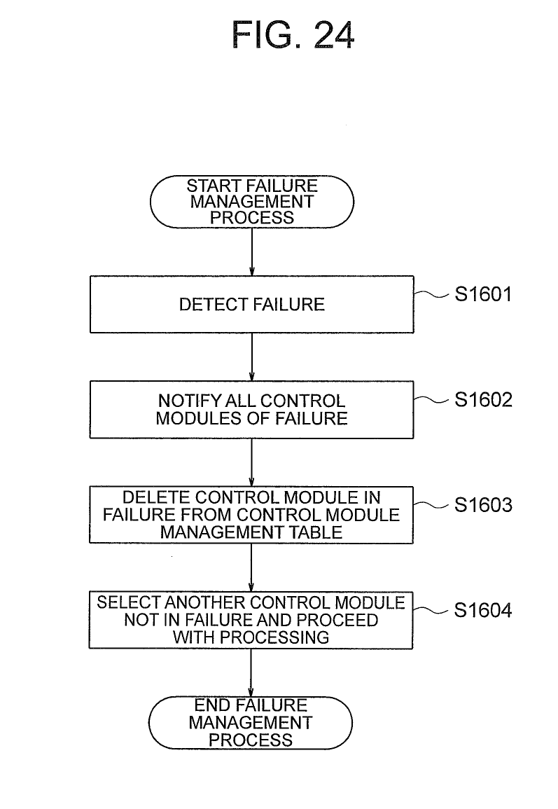

FIG. 24 is a flow chart of a procedure to be followed when a control module becomes unavailable in the third embodiment. Here, a description will be made of a case in which the management section 251 and the management section 253 use the management section 252, and the management section 252 becomes unavailable.

In step S1601, either the management section 251 or the management section 253 detects a failure of the management section 252. A response step associated with each communication procedure may be provided to detect the failure. For example, immediately after the management section 253 makes communication to the management section 252 in step 323 in FIG. 21, the management section 252 may return, a response associated with the communication of step 323.

In step S1602, upon detecting a failure, either the management section 251 or the management section 253 notifies all the other control modules of the module number of the control module that is detected to be in failure.

In step 1603, if the control module that receives the notification has in its control module management table the failed control module of which the control module number is notified, the control module deletes the information on the failed control module from the control module management table and decrements the number of connections in the control module management table by 1. In the case described here, the management section 251 and the management section 253 delete the management section 252 from their control module management tables.

In step S1604, another control module that is not in failure is selected and proceeds with the processing. Here, the management section 254 is selected as a substitute for the management section 252.

A failure in the management section 254 that is not selected in step 307 or other steps in FIG. 21 cannot be detected by the above procedure. Therefore, the master control module may send a connection query at regular intervals to detect a failure. In this case, since the master control module of the management section 254 is the management section 251 as stated in the control module connection table or Table 5, the management section 251 sends a connection query to the management section 254 at regular intervals and detects whether or not a response is retuned. When the management section 251 detects a failure of the management section 254, the management section 251 notifies all the other control modules of the module number of the control module that is detected to be in failure. Then, the management section 251 and the management section 253 delete the management section 254 from the control module management tables. The management section 252 can continue to be used even if the management section 254 is in failure, and the management section 252 is selected as the destination of the communication without change in step 307 and other steps.

### (Operations and Advantages)

In the control unit 420, the distributed processing system, and the distributed processing method using the same according to the third embodiment, a plurality of control modules having the same function as that of a management section may be started as backups for that management section as with the other control modules. This enhances the failure tolerance of the system with a failure(s) and improves the maintainability.

The configurations, operations, and advantages other than those described above are the same as those according to the above described embodiments.

### Fourth Embodiment

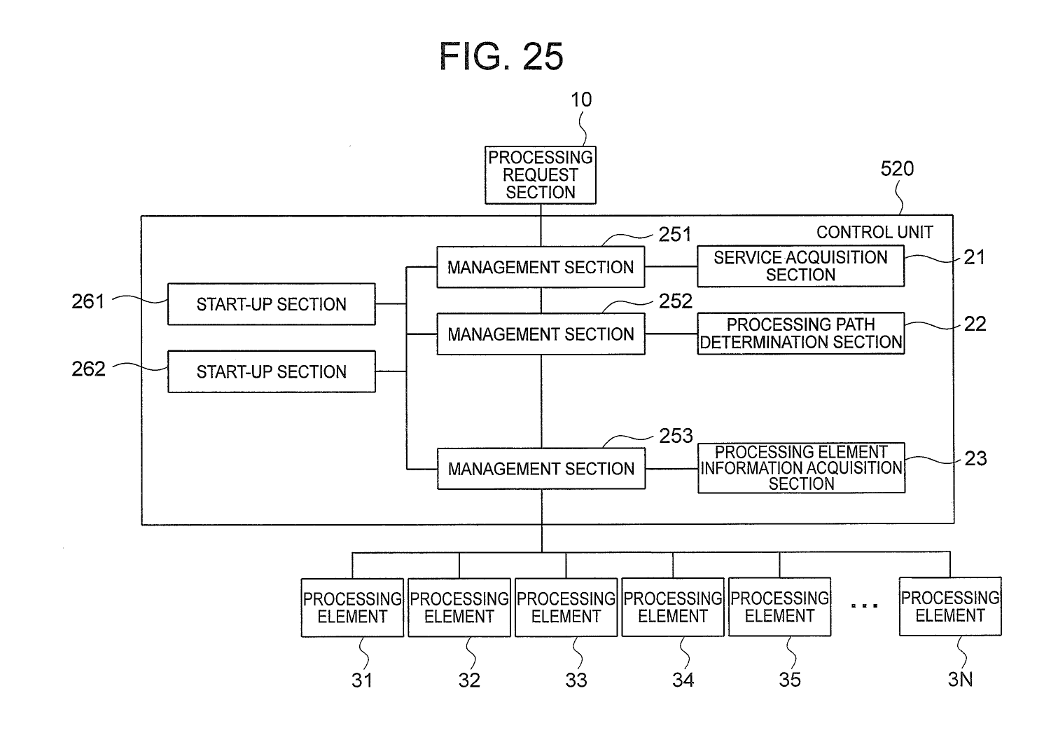

FIG. 25 is a diagram showing the overall configuration of a distributed processing system as well as the internal configuration of a control unit 520 according to a fourth embodiment.

In the control unit 520 (distributed controller) shown in FIG. 25, a start-up section 261 and a start-up section 262 are defined as new control modules. The start-up sections 261, 262 are connected to management sections 251, 252, 253. The start-up section can start a designated control module. Therefore, in cases where the system is implemented as software, the system can automatically start a backup control module by specifying a copy of the control module. The start-up section is a kind of control module, which starts up in accordance with the procedure shown in FIG. 12. Connections between the start-up section and other modules are managed with the control module management table 2200.

In the following, a case in which the management section 252 creates a copy of a control module using the start-up sections 261 and 262 will be discussed.

Each management section 251, 252, 253 has the maximum number of connections, which is equal to the total number of the control modules that can be connected to that management section. It is assumed that the maximum number of the control modules having the same function that can be connected to the management section is limited for each function provided by control modules specified by a module number. An example of information specifying a limitation on the number of connections is shown in Table 6. Table 6 is a table stating the maximum numbers of connections used in the management section 252. In the case described here, it is assumed that the maximum number of connections of the management section 252 is 20, and any number of control modules that have a function not referred to in this table can be connected as long as the maximum number of connections of the management section 252 is not exceeded. In the case where a table stating the maximum number of connections is not defined, all the kinds of control modules can be connected as desired as long as the maximum number of connections is not exceeded.

TABLE 6

| control module number | maximum number of connections |
|---|---|
| 1-2-X-X | 4 |
| 0-2-1111-X | 4 |
| 0-2-2222-X | 3 |
| 1-3-X-X | 3 |

The management section 251, 252, 253 hold a token in common. The token is sent and received between the management sections. For example, the token is circulated in order from the management section 251 to the management section 252, then to the management section 253, then to the management section 252, and then back to the management section 251.

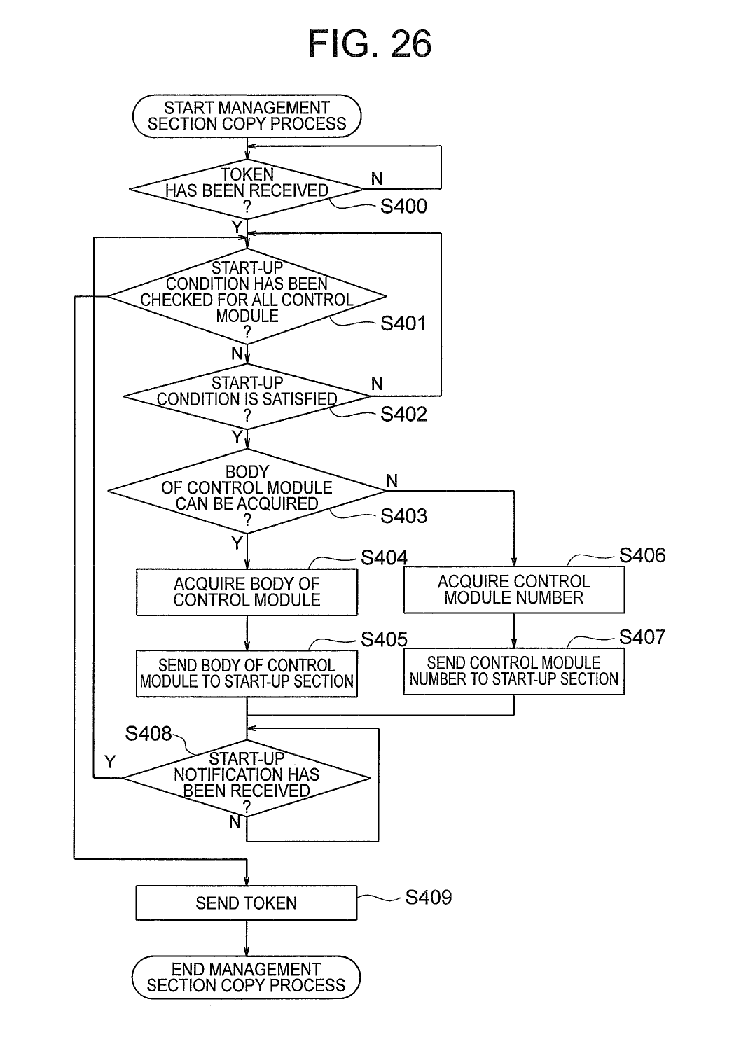

FIG. 26 is a flow chart of a copy process executed in the management section 252.

In step S400, the management section 252 determines whether or not it has received the token from the management section 251. If the management section 252 has not received the token (N in step S400), it stays in standby until receiving the token. If the management section 252 has received the token (Y in step S400), the process proceeds to step S401.

In step S401, the management section 252 determines whether or not it has checked a start-up condition for all the control modules including itself listed in the control module management table. If it is determined by the management section 252 that the start-up condition has been checked for all the control modules (Y in step S401), the process proceeds to step S409.

If it is determined by the management section 252 that the start-up condition has not been checked for all the control modules (N in step S401), the process proceeds to step S402. In step S402, the management section 252 determines whether or not all the connected control modules satisfy the start-up condition. A determination as to whether or not a certain module satisfies the start-up condition may be made by determining whether or not the creation of a copy of this control module will cause the maximum number of connection to be reached, or by determining whether or not the continuous operating time exceeds a specified time. The continuous operating time is managed with the control module management table 2200, and each management section knows the mean time between failure (MTBF) (or the average duration since the start of a control module until it become faulty) of the control modules connected thereto in the past. If there is a control module operating continuously more than 60 percent of the MTBF, a copy thereof is created. If all the control modules are operating continuously more than 60 percent of the MTBF and the maximum number of connections is reached, one or more of the control modules may be disconnected, and a new control module may be designated in the start-up section. If the number of connections will not reach the maximum number of connections and the control modules are operating continuously more than 60 percent of the specified time, the start-up condition is satisfied. Then, the process proceeds to step S403 (Y in step S402).

If it is determined by the management section 252 that the start-up condition is not satisfied (N in step S402), it makes a determination of the start-up condition for the next control module.

In step S403, the management section 252 checks whether or not a body of the control module can be acquired. If the control module to be copied is the management section 252 itself, the management section 252 creates its own copy to acquire the body of the control module. In some cases, the control module to be copied may be another control module, and a copy of the another control module can be acquired from a server that manages control modules. If the body of the control module can be acquired (Y in step S403), the management section 252 creates its own copy to acquire the body of the control module or acquire the body of the control module of another control module from, for example, a server (step S404). Then, process proceeds to step S405. In step S405, the management section 252 sends the acquired body of the control module to either the start-up section 261 or the start-up section 262, and then process proceeds to step S408.

On the other hand, if it is determined in step S403 that the body of the control module cannot be acquired (N in step S403), the management section 252 acquires a module number that uniquely specifies the control module to be copied (step S406), and the process proceeds to step S407. In step S407, the management section 252 sends the acquired module number to either the start-up section 261 or the start-up section 262, and the process proceeds to step S408.

In step S408, the management section 252 determines whether or not it has received a start-up notification from the started copy of the control module. It is assumed that the copied control module sends a start-up notification as a confirmation signal. If it is determined in step S408 that the management section 252 has received the start-up notification (Y in step S408), the process returns to step S401. If it is determined that the management section 252 has not received the start-up notification (N in step S408), it stays in standby.

In step S409, the management section 252 sends the token to the management section 253, and the copy process in the management section 252 is terminated. The copy process may be suspended and the token may be forcibly sent to the management section 253 when a predetermined period of time has elapsed.

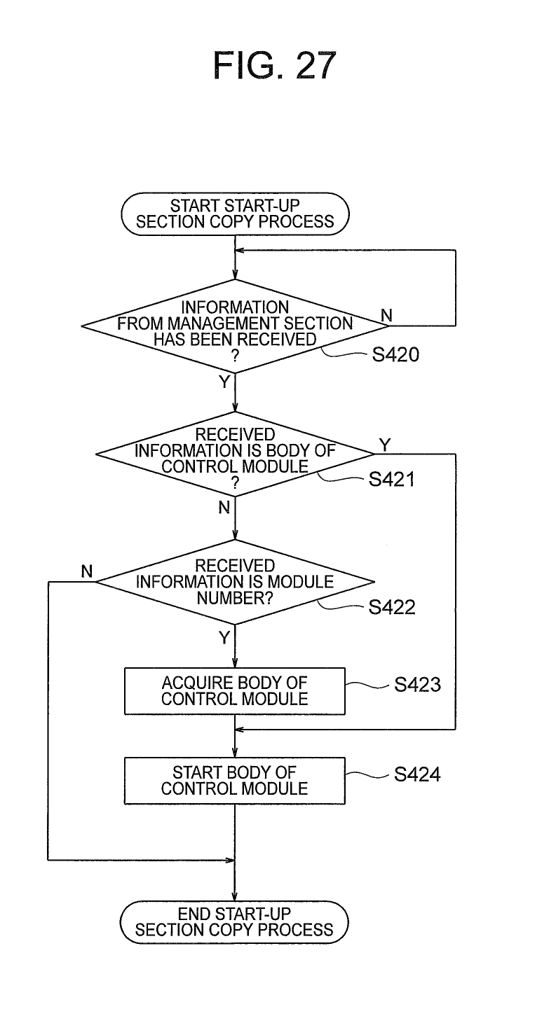

FIG. 27 is a flow chart of a copy process in the start-up section.

In step S420, the start-up section determines whether or not it has received information from the management section. If it is determined that the start-up section has received the information (Y in step S420), the process proceeds to step S421. If it is determined that the start-up section has not received the information (N in step S420), it stays in standby.

In step S421, the start-up section checks whether or not the received information is a body of a control module. If the received information is the body of the control module (Y in step 421), the process proceeds to step S424. If the start-up section has not received the body of the control module (N in step S421), the process proceeds to step S422.

In step S422, the start-up section checks whether or not the received information is a module number. If the received information is a module number (Y in step S422), the process proceeds to step S423. If the received information is not a module number (N in step S422), the start-up section concludes that it has received unexpected information and terminates the process.

In step S423, the start-up section acquires a body of the control module designated by the module number from, for example, a server, and then the process proceeds to step S424.

In step S424, the start-up section starts the acquired body of the control module, and then terminates the process. The control module can be started only on the computer on which the start-up section runs. Therefore, as an exceptional case, the start-up section and the copy of the control module that is designated by another control module and started by the start-up section run on the same computer shown in FIG. 10.

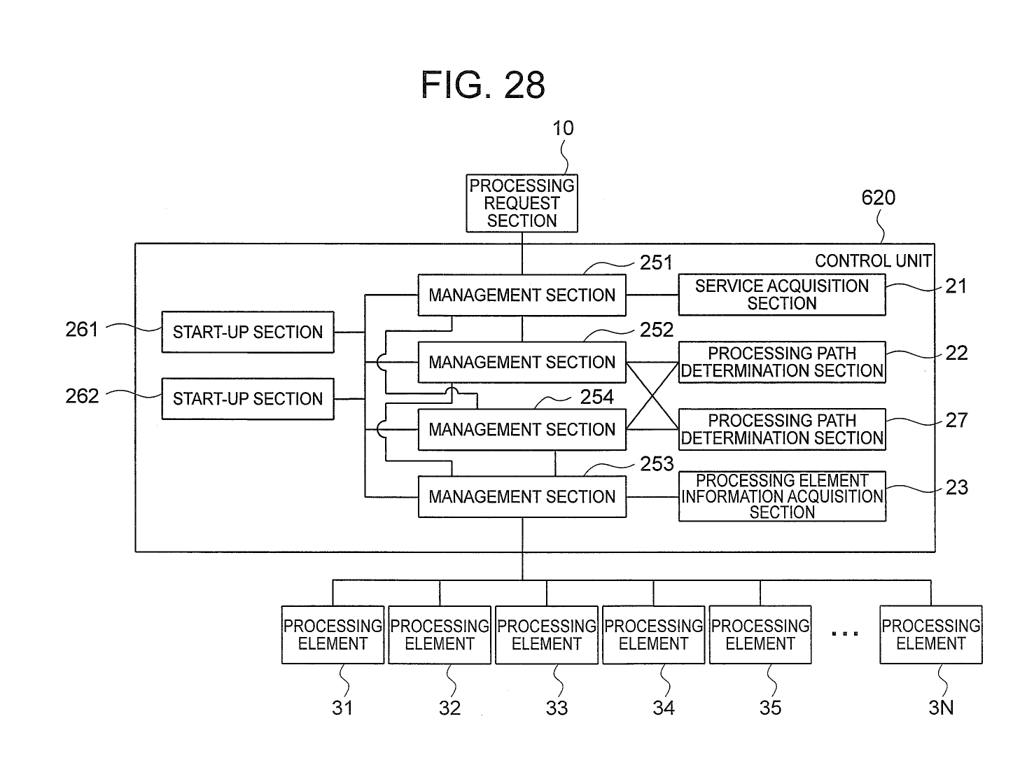

FIG. 28 is a diagram showing the overall configuration of the processing system as well as the internal configuration of the control unit 620 after the completion of the copy process according to the fourth embodiment.

It is assumed that the management section 252 has designated a copy of the management section 252 itself for the start-up section 261 and the module number of the processing path determination section 22 for the start-up section 262. The copy of the management section 252 is referred to as a management section 254, and the copy of the processing path determination section 22 is referred to as the processing path determination section 27. The start-up section 262 holds the copies of all the control modules shown in FIG. 25 in an internal server and can acquire copies of them as desired.

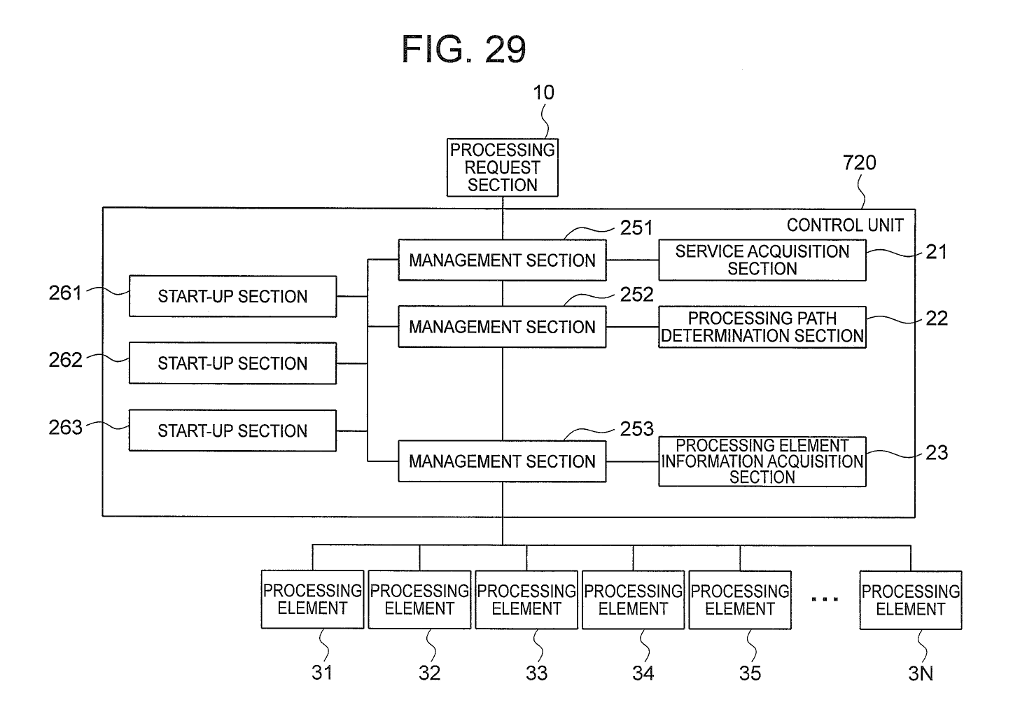

FIG. 29 is a diagram showing the overall configuration of the distributed processing system after the completion of the copy process in the start-up section, in which the control unit 720 has been started.

In FIG. 29, a copy of the start-up section 262 has been started as the star-up section 263. If there are a plurality of start-up sections, the copy of the star-up section can be started in accordance with the start-up condition same as that used in the case of other control modules. The copied control module sends a start notification and autonomously makes connections to other control modules.

### (Operations and Advantages)

In the distributed controller, the distributed processing system, and the distributed processing method according to the fourth embodiment, the start-up sections 261, 262 allow a backup control module to start automatically beforehand based on a start-up condition. This further improves the maintainability. A backup of the start-up section itself can be also created by starting a plurality of start-up sections beforehand.

The use of a token or the like prevents copies of the plurality of control modules from operating at the same time. This prevents a failure in the reception of information on the connection destination, which would occur if the information were sent during the start-up of the control module and failed to be received. Therefore, the omission of the connection process is prevented from occurring. Thus, the probability of the occurrence of failure is reduced, and the maintainability is improved.

The configurations, operations, and advantages other than those described above are the same as those according to the above described embodiments.

The distributed controller, the distributed processing system, and the distributed processing method according to the present invention can suitably be applied to a system in which a control unit requires high serviceability.

The distributed controller, the distributed processing system, and the distributed processing method according to the present invention are advantageous in that the serviceability of a control unit that controls processing elements to perform distributed processing is improved.

What is claimed is:

1. A distributed controller that is connected to two or more processing elements, controls the two or more processing elements to execute distributed processing, and comprises a plurality of control modules, wherein each of the control modules is connected to at least one other control module, and a processing path between the processing elements is determined by using at least two of the plurality of control modules.

2. A distributed controller according to claim 1, wherein
each of the plurality of control modules holds distributed controller connection information that defines a connection relationship with another control module, and
each of the plurality of control modules issues a request for connection or determines whether or not to make a connection in response to a request for connection from another control module based on the distributed controller connection information, and establishes a connection autonomously.

3. A distributed controller according to claim 2, wherein the control module notifies another control module of start-up at the time of start-up to trigger the another control module to issue a request for connection.

4. A distributed controller according to claim 2, wherein the control module acquires control module information about the another control modules with which the connection has been established and issues a request for connection again to the control module written in the control module information when the connection with the control module is disconnected.

5. A distributed controller according to claim 1, wherein a service acquisition unit that analyzes a requested task and acquires information on services that constitute the task, a processing element information acquisition unit that acquires information on the connected processing element, and a processing path determination unit that determines a processing path for executing distributed processing of the services using information on the services and information on the processing element are assigned to two or more of the plurality of control modules.

6. A distributed controller according to claim 1, wherein the distributed controller comprises a management unit that manages the control module information of at least one connected control modules among the plurality of the control modules, and the management unit selects the control modules that constitute the distributed controller using the control module information and a predetermined selection condition, the management unit being one of the control modules.

7. A distributed controller according to claim 6, wherein the management unit is constituted by one control module.

8. A distributed controller according to claim 6, wherein the management unit is constituted by a plurality of control modules.

9. A distributed controller according to claim 5, wherein different management units are assigned to the service acquisition unit, the processing element information acquisition unit, and the processing path determination unit respectively.

10. A distributed controller according to claim 6, wherein a plurality of processing path determination units that determine processing paths by different processing path determination methods are assigned to different control modules.

11. A distributed controller according to claim 6, wherein different kinds of processing element information or a combination of the different kinds of processing element information are assigned to different processing element information acquisition units, and a management unit that manages a processing element information acquisition unit selects a processing element information acquisition unit based on the control module information in such a way as to satisfy a selection condition in which the management unit acquires information needed for a processing path determination unit selected by a management unit that manages the processing path determination unit to determine processing paths.

12. A distributed controller according to claim 6, wherein the control module makes connections to a plurality of control modules having the same function and acquires their control module information, and if it is determined that the selected control module is not usable, the control module reselects a control module having the same function based on the control module information.

13. A distributed controller according to claim 1, wherein the distributed controller comprises a start-up unit that starts a control module designated by another control module based on a start-up condition, the start-up unit being one of the control modules.

14. A distributed controller according to claim 13, wherein the control module designates a copy of itself for the start-up unit.

15. A distributed controller according to claim 13, wherein the start-up unit holds a copy of a control module and starts the copy according to a designation made by another control module.

16. A distributed controller according to claim 13, wherein the control module designates a copy to be started for the start-up unit in such a way as not to cause duplication of another control module simultaneously.

17. A distributed processing system comprising:
two or more processing elements; and
a distributed controller that is connected to the two or more processing elements and controls the two or more processing elements to execute distributed processing,
wherein the distributed controller comprises a plurality of control modules,
each of the control modules is connected to at least one other control module, and
a processing path between the processing elements is determined using at least two of the plurality of control modules.

18. A distributed processing method for a distributed processing system including two or more processing elements and a distributed controller connected to the two or more processing elements, the distributed controller including a plurality of control modules, each of the control module being connected to at least one other control module, the method comprising:
determining a processing path between the processing elements using at least two of the plurality of control modules; and
executing distributed processing by the processing elements in the processing path under control of the distributed controller.
